(19) United States
(12) Patent Application Publication
(10) Pub. No.: US 2007/0046725 A1
(43) Pub. Date: Mar. 1, 2007

(54) Printing method, printing system, and storage medium storing program

(75) Inventors: Yoshiko Hoshiyama, Nagano-ken (JP); Hirokazu Nunokawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/511,481

(22) Filed: Aug. 29, 2006

(30) Foreign Application Priority Data
Aug. 29, 2005 (JP) 2005-248301

(51) Int. Cl. B41J 2/15; B41J 2/145

(52) U.S. Cl. 347/40

(57) ABSTRACT

A printing method includes setting an initial position according to a length of a medium in a carrying direction; carrying the medium to the initial position that has been set; and arranging in the carrying direction on the medium a plurality of dot rows each constituted by a plurality of dots that are aligned in a movement direction, by repeating alternately a dot forming process for forming a dot on the medium by ejecting a liquid droplet from a plurality of nozzles that move in the movement direction and a carrying process for carrying the medium in the carrying direction.

### CROSS-REFERENCE TO RELATED APPLICATIONS

The present application claims priority from Japanese Patent Application No. 2005-248301 filed on Aug. 29, 2005 which is herein incorporated by reference.

### BACKGROUND

1. Technical Field

The present invention relates to printing methods, printing systems, and storage media storing a program.

2. Related Art

In inkjet printers, a print image is printed on paper by repeating alternately a dot forming process for forming dots on paper by ejecting ink droplets from a plurality of nozzles that move, and a carrying process for carrying paper in a carrying direction, thereby arranging a plurality of dot rows (raster lines) in the carrying direction on paper. Before these dot forming process and carrying process are repeated, a paper supply process in which paper is supplied to a print area is performed (see JP-A-2003-54057).

In ordinary cases, the position of paper after the paper supply process is set to the same position regardless of the paper size or the like. In particular, in the same print mode, the position of paper after the paper supply process is the same position regardless of the paper size or the like.

If the position of paper after the paper supply process is constant, however, then it is necessary to change the dot forming process or the carrying process in accordance with the length of the paper in the carrying direction when the vicinity of a lower end of the paper is printed. However, if the dot forming process or the carrying process is changed in accordance with the length of the paper in the carrying direction, then the processes become complex.

### SUMMARY

Accordingly, an advantage of some aspects of the present invention makes it possible to perform a dot forming process and a carrying process in the same manner regardless of the length of paper in a carrying direction.

A main aspect of the present invention in order to achieve the above-described advantage is a printing method including: setting an initial position according to a length of a medium in a carrying direction; carrying the medium to the initial position that has been set; and arranging in the carrying direction on the medium a plurality of dot rows each constituted by a plurality of dots that are aligned in a movement direction, by repeating alternately a dot forming process for forming a dot on the medium by ejecting a liquid droplet from a plurality of nozzles that move in the movement direction and a carrying process for carrying the medium in the carrying direction.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings.

FIG. 1 is an explanatory view showing the overall configuration of a printing system.

FIG. 2 is an explanatory view of a user interface of a printer driver.

FIG. 3 is a block diagram of the overall configuration of a printer 1.

FIG. 4A is a schematic view of the overall configuration of a printer 1, and FIG. 4B is a cross-sectional view of the overall configuration of the printer 1.

FIG. 5 is an explanatory diagram illustrating the arrangement of nozzles on a lower face of a head 41.

FIG. 6 is a flowchart of processes during printing.

FIG. 7A is an explanatory diagram of band printing, showing the position of a head (or nozzles) in a single pass and the manner in which dots are formed in the single pass. FIG. 7B is an explanatory diagram of band printing, showing the position of the head in a next pass and the manner in which dots are formed in the next pass.

FIG. 8A is an explanatory diagram of overlap printing, showing positions of a head in pass 1 and pass 2 and the manner in which dots are formed in pass 1 and pass 2. FIG. 8B is an explanatory diagram of overlap printing, showing positions of the head in pass 1 to pass 3 and the manner in which dots are formed in pass 1 to pass 3.

FIG. 9A is an explanatory diagram of interlaced printing, showing positions of a head (or nozzle group) in pass 1 to pass 4 and the manner in which dots are formed in pass 1 to pass 4. FIG. 9B is an explanatory diagram of interlaced printing, showing positions of the head in pass 1 to pass 6 and the manner in which dots are formed in pass 1 to pass 6.

FIG. 10A is an explanatory diagram of full overlap printing, showing positions of a head in pass 1 to pass 8 and the manner in which dots are formed in pass 1 to pass 8. FIG. 10B is an explanatory diagram of full overlap printing, showing positions of the head in pass 1 to pass 11 and the manner in which dots are formed in pass 1 to pass 11.

FIG. 11A is an explanatory diagram of a state in which a print image is properly formed on paper. FIG. 11B is an explanatory diagram of a state in which the image quality of a print image is partially deteriorated due to various reasons.

FIG. 12A is an explanatory view of a state in which a lower end of paper S is held between a carry roller 23 and a first driven roller 26. FIG. 12B is an explanatory view of a state at the time of starting BS control.

FIG. 13 is an explanatory diagram of a first printing method in a case where the number of nozzles is eight.

FIG. 14 is an explanatory diagram of the first printing method in a case where the number of nozzles is 180.

FIG. 15 is an explanatory diagram of a second printing method in a case where the number of nozzles is eight.

FIG. 16 is an explanatory diagram of the second printing method in a case where the number of nozzles is 180.

FIG. 17A is an explanatory diagram of a printing method in a comparative example, and shows positions of a head with respect to paper when paper S1 with a length L1 in a carrying direction is printed. FIG. 17B is an explanatory diagram of a printing method in a comparative example, and shows positions of the head with respect to paper when paper S2 with a length L2 in the carrying direction is printed.

FIG. 18 is an explanatory diagram of a printing method in a first embodiment.

FIG. 19A is an explanatory view of the position of an upper end when paper S1 is supplied. FIG. 19B is an explanatory view of the position of the upper end when paper S2 is supplied.

FIG. 20A is an explanatory view of a state during an ordinary carrying process. FIG. 20B is an explanatory view of a state during a carrying process after a lower end of paper has passed a carry roller.

FIG. 21 is an explanatory diagram of a printing method in which printing is completed before a lower end has passed a carry roller.

FIG. 22 is an explanatory diagram of a printing method in a second embodiment.

### DESCRIPTION OF EXEMPLARY EMBODIMENTS

At least the following matters will be made clear by the explanation in the present specification and the description of the accompanying drawings.

An aspect of the present invention is directed to a printing method including:

setting an initial position according to a length of a medium in a carrying direction;

carrying the medium to the initial position that has been set; and

arranging in the carrying direction on the medium a plurality of dot rows each constituted by a plurality of dots that are aligned in a movement direction, by repeating alternately a dot forming process for forming a dot on the medium by ejecting a liquid droplet from a plurality of nozzles that move in the movement direction and a carrying process for carrying the medium in the carrying direction.

With this printing method, it is possible to perform a dot forming process and a carrying process in the same manner regardless of the length of paper in a carrying direction.

Furthermore, it is preferable that when a plurality of the dot rows are arranged in the carrying direction on the medium, the dot row is formed in a first print mode in an area of a central portion of the medium, and the dot row is formed in a second print mode that is different from the first print mode in an area away from a lower end of the medium by a predetermined distance. Thus, it is possible to perform a dot forming process and a carrying process in the same manner regardless of the length of paper in a carrying direction when printing is performed in the vicinity of a lower end.

Furthermore, it is preferable that in the first print mode, the dot row is formed by a predetermined number of nozzles, and that in the second print mode, the dot row is formed by a predetermined number of nozzles that is different from the predetermined number of the nozzles in the first print mode. Thus, it is possible to perform printing at various image qualities.

Furthermore, it is preferable that, between a first area in which a plurality of the dot rows formed by the predetermined number of the nozzles in the first print mode are arranged and a second area in which a plurality of the dot rows formed by the predetermined number of the nozzles in the second print mode are arranged, a mixed area is formed in which the dot rows formed by the predetermined number of the nozzles in the first print mode and the dot rows formed by the predetermined number of the nozzles in the second print mode are present in a mixed state. Thus, it is possible to suppress deterioration of the image quality of the entire print image.

Furthermore, it is preferable that in the mixed area, more than half the dot rows formed by the predetermined number of the nozzles in the first print mode are formed at positions closer to the first area than to the second area. Thus, it is possible to further suppress deterioration of the image quality of the entire print image.

Furthermore, it is preferable that if the dot row on a most upstream side in the carrying direction among the dot rows that are to be formed on the medium is positioned on a downstream side in the carrying direction than a position away from the lower end by the predetermined distance, the dot row on the most upstream side in the carrying direction is formed in the second print mode. Thus, it is possible to perform printing at a high image quality.

Furthermore, it is preferable that if the dot row on the most upstream side in the carrying direction among the dot rows that are to be formed on the medium is positioned on an upstream side in the carrying direction than the position away from the lower end by the predetermined distance, carrying of the medium to the initial position according to the length of the medium in the carrying direction is not performed, because it is not necessary in this case.

An aspect of the present invention is directed to a printing system including:

a carry unit for carrying a medium in a carrying direction;

a moving member for moving a plurality of nozzles in a movement direction; and

a controller
for setting an initial position according to a length of the medium in the carrying direction and letting the carry unit carry the medium to the initial position that has been set, and
for arranging in the carrying direction on the medium a plurality of dot rows each constituted by a plurality of dots that are aligned in the movement direction, by repeating alternately a dot forming process for forming a dot on the medium by ejecting a liquid droplet from a plurality of the nozzles that move in the movement direction and a carrying process for carrying the medium in the carrying direction by the carry unit.

With this printing system, it is possible to perform a dot forming process and a carrying process in the same manner regardless of the length of paper in a carrying direction.

An aspect of the present invention is directed to a storage medium storing a program that lets a printing system realize:
a function to set an initial position according to a length of a medium in a carrying direction;
a function to carry the medium to the initial position that has been set; and
a function to arrange in the carrying direction on the medium a plurality of dot rows each constituted by a plurality of dots that are aligned in a movement direction, by repeating alternately a dot forming process for forming a dot on the medium by ejecting a liquid droplet from a plurality of nozzles that move in the movement direction and a carrying process for carrying the medium in the carrying direction.

With this program, it is possible to let a printing apparatus perform a dot forming process and a carrying process in the same manner regardless of the length of paper in a carrying direction.

Configuration of Printing System

Next, embodiments of the printing system are described with reference to the drawings. However, the description of the following embodiments also encompasses embodiments relating to a computer program and a storage medium storing the computer program, for example.

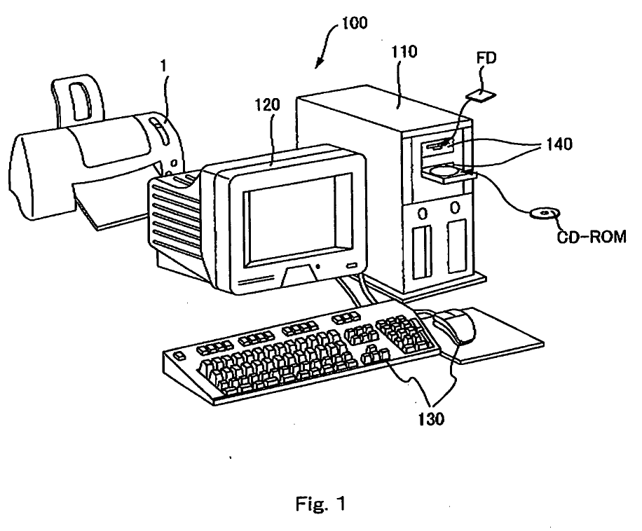

FIG. 1 is an explanatory view showing the external configuration of the printing system. A printing system 100 is provided with a printer 1, a computer 110, a display device 120, input devices 130, and recording/reproducing devices 140. The printer 1 is a printing apparatus for printing images on a medium such as paper, cloth, or film. The computer 110 is communicably connected to the printer 1, and outputs to the printer 1 print data that corresponds to an image to be printed so that the image is printed by the printer 1.

A printer driver is installed on the computer 110. The printer driver is a program for letting a user interface be displayed on the display device 120, and for letting image data output from an application program be converted into print data. The printer driver is stored on a storage medium (computer-readable storage medium) such as a flexible disk FD or a CD-ROM. Alternatively, the printer driver also can be downloaded onto the computer 110 via the Internet. It should be noted that this program is made of codes for realizing various functions.

Note also that a “printing apparatus” refers to an apparatus that prints images on a medium, and corresponds to, for example, the printer 1. Furthermore, a “printing control device” refers to a device that controls the printing apparatus, and corresponds to, for example, a computer on which the printer driver is installed. Furthermore, a “printing system” refers to a system that includes at least the printing apparatus and the printing control device.

Printer Driver

Regarding Printer Driver

The printer driver receives image data from the application program, and converts the image data into print data in a format that can be interpreted by the printer 1, and outputs the print data to the printer. When the image data from the application program is converted into the print data, the printer driver performs a resolution conversion process, a color conversion process, a halftone process, a rasterization process, and a command addition process, for example. Hereinafter, the various processes performed by the printer driver are described.

The resolution conversion process is a process in which image data (such as text data and picture data) output from the application program is converted into resolution (print resolution) with which the image is to be printed on paper. For example, when the print resolution has been specified as 720×720 dpi, then vector image data obtained from the application program is converted into bitmap image data with resolution of 720×720 dpi. It should be noted that after the resolution conversion process, each pixel data of the image data is multi-gradation RGB data (such as 256 gradations) that are expressed in RGB color space.

The color conversion process is a process in which RGB data is converted into CMYK data that is expressed in CMYK color space. It should be noted that CMYK data is data that corresponds to the ink colors of the printer. This color conversion process is performed based on a table (Color Conversion Lookup Table LUT) in which gradation values of RGB data are associated with gradation values of CM data. It should be noted that after the color conversion process, pixel data is CMYK data with 256 gradations expressed in CMYK color space.

The halftone process is a process in which data of a high number of gradations is converted into data of a number of gradations that can be formed by the printer. For example, in the halftone process, data expressing 256 gradations are converted into 1-bit data expressing two gradations or 2-bit data expressing four gradations. In the halftone process, dithering, γ-correction, and error diffusion, for example, are used. Data that has undergone the halftone process has a resolution similar to the print resolution (such as 720×720 dpi). In the image data after the halftone process, 1-bit or 2-bit image data corresponds to each pixel, and this pixel data is data indicating a dot forming status (presence or absence of a dot and the size of a dot) for each pixel.

The rasterization process is a process in which pixel data arranged in a matrix is rearranged following the dot formation order during printing. For example, if a dot forming process is performed several times during printing, then pixel data corresponding to the dot forming processes is extracted each by each and is rearranged following the order of the dot forming processes. It should be noted that if print modes are different, then the dot formation orders during printing are different. Thus, the rasterization process is performed in accordance with the print mode.

The command addition process is a process in which command data according to the print mode is added to data that has undergone the rasterization process. Examples of command data include carry data indicating the carry amount.

Print data that has been created through these processes is transmitted by the printer driver to the printer.

Regarding Settings of Printer Driver

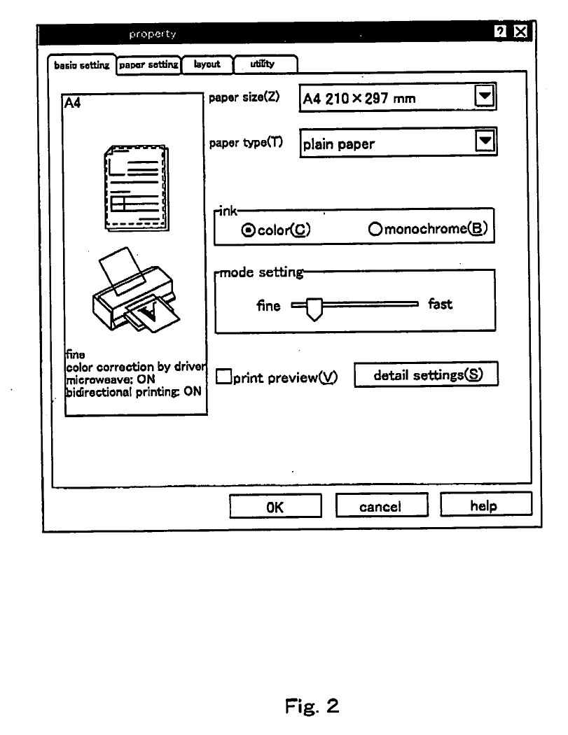

FIG. 2 is an explanatory view of the user interface of the printer driver. The user interface of the printer driver is displayed on the display device in accordance with a request from the printer driver. A user can set various settings of the printer driver by using the input devices 130.

For example, the user can set basic settings such as the paper size or the paper type on a screen. Furthermore, the user can select whether to perform color printing or monochrome printing, and adjust whether to perform “fine” printing or to make the print speed fast.

The printer driver creates print data in accordance with the setting details. For example, if the settings “plain paper” and “fast” are selected, then the printer driver creates print data such that printing is possible in a print mode in which the resolution is low and the carry amount is large. Furthermore, if the settings “gloss paper” and “fine” are selected, then the printer driver creates print data such that printing is possible in a print mode in which the resolution is high and the carry amount is small.

In this embodiment, if the user selects a “paper size” when setting the printer driver, then it is possible for the printer driver to acquire information relating to the paper size and to determine the length of paper in the carrying direction. Although not shown in the drawing, it is also possible to enable the user to select a direction (vertical or horizontal) of paper during printing when setting the printer driver, so that it is possible for the printer driver to determine the length of the paper in the carrying direction based on information relating to the direction of the paper and information relating to the paper size.

Furthermore, the printer driver creates command data for a paper supply process (described later) in accordance with the length of paper in the carrying direction, and transmits print data including this command data to the printer. The printer supplies paper to the position according to the length of the paper in the carrying direction by performing the paper supply process in accordance with the command data.

Configuration of Printer

Regarding Configuration of Inkjet Printer

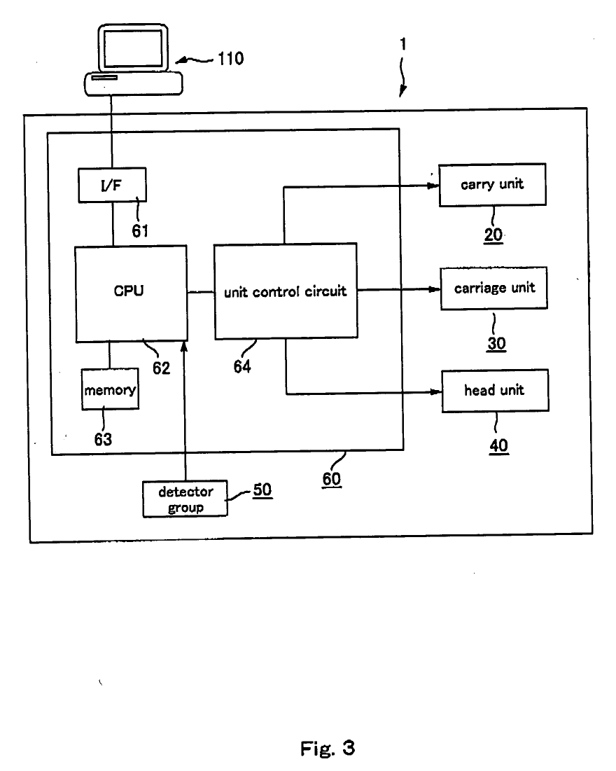

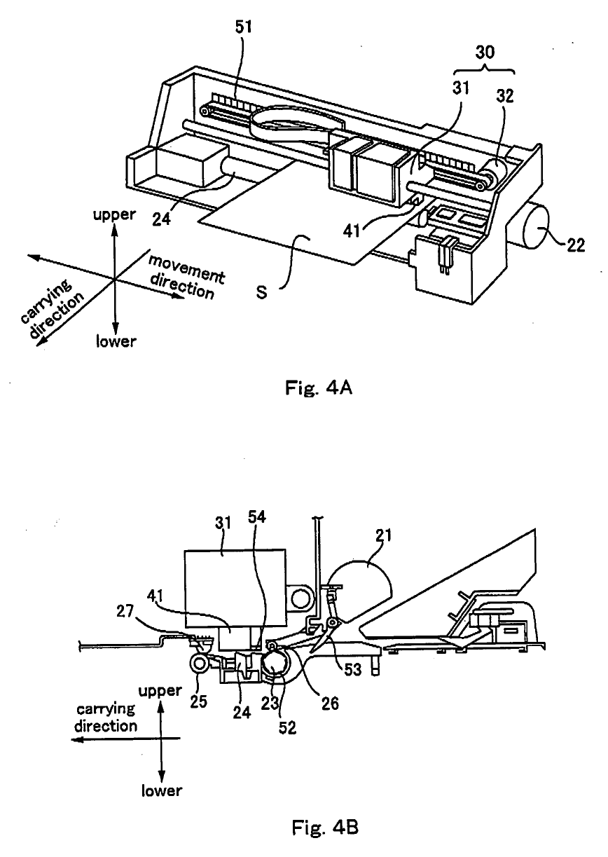

FIG. 3 is a block diagram of the overall configuration of the printer 1. FIG. 4A is a schematic view of the overall configuration of the printer 1. FIG. 4B is a cross-sectional view of the overall configuration of the printer 1. Hereinafter, the basic configuration of the printer is described.

The printer 1 has a carry unit 20, a carriage unit 30, a head unit 40, a detector group 50, and a controller 60. The printer 1 that has received print data from the computer 110, which is an external device, controls each of the units (the carry unit 20, the carriage unit 30, and the head unit 40) using the controller 60. The controller 60 controls each of the units and prints an image on paper based on the print data received from the computer 110. The conditions within the printer 1 are monitored by the detector group 50, and the detector group 50 outputs results of this detection to the controller 60. The controller 60 controls each of the units based on the detection results that are output from the detector group 50.

The carry unit 20 is for carrying a medium (such as paper S) in a predetermined direction (hereinafter referred to as a “carrying direction”). The carry unit 20 has a paper supply roller 21, a carry motor 22 (also referred to as a “PF motor”), a carry roller 23, a platen 24, and a paper discharge roller 25. The paper supply roller 21 is a roller for supplying paper that has been inserted into a paper insert opening, into the printer. The carry roller 23 is a roller for carrying to a printable area the paper S that has been supplied by the paper supply roller 21, and is driven by the carry motor 22. The platen 24 supports the paper S during printing. The paper discharge roller 25 is a roller for discharging the paper S to outside the printer, and is provided on the downstream side in the carrying direction with respect to the printable area. The carry unit 20 is provided with a first driven roller 26 and a second driven roller 27. The first driven roller 26 is provided at the position opposed to the carry roller 23 such that the paper S is held between the first driven roller 26 and the carry roller 23 when carrying the paper. The second driven roller 27 is provided at a position opposed to the paper discharge roller 25 such that the paper S is held between the second driven roller 27 and the paper discharge roller 25 when carrying the paper.

The carriage unit 30 is for moving a head (also referred to as “scan”) in a predetermined direction (hereinafter referred to as a “movement direction”). The carriage unit 30 has a carriage 31 and a carriage motor 32 (also referred to as a “CR motor”). The carriage 31 can move back and forth in the movement direction, and is driven by the carriage motor 32. Furthermore, the carriage 31 detachably holds ink cartridges containing ink.

The head unit 40 is for ejecting ink onto paper. The head unit 40 is provided with a head 41 having a plurality of nozzles. The head 41 is provided in the carriage 31, and thus when the carriage 31 moves in the movement direction, the head 41 also moves in the movement direction. The head 41 intermittently ejects ink while moving in the movement direction, and thereby dot lines (raster lines) are formed on the paper along the movement direction.

The detector group 50 includes a linear encoder 51, a rotary encoder 52, a paper detection sensor 53, an optical sensor 54, and the like. The linear encoder 51 detects the position of the carriage 31 in the movement direction. The rotary encoder 52 detects the amount of rotation of the carry roller 23. The paper detection sensor 53 detects the position of the front end of paper that is being supplied. The optical sensor 54 detects whether or not paper is present by a light-emitting section and a light-receiving section which are attached to the carriage 31. The optical sensor 54 can detect the width of the paper by detecting the positions of the end sections of the paper while being moved by the carriage 31. Depending on the circumstances, the optical sensor 54 can also detect the front end (the end section on the downstream side in the carrying direction; also referred to as an upper end) and the rear end (the end section on the upstream side in the carrying direction; also referred to as a lower end) of the paper.

The controller 60 is a control unit (controller) for controlling the printer. The controller 60 has an interface section 61, a CPU 62, a memory 63, and a unit control circuit 64. The interface section 61 exchanges data between the computer 110, which is an external device, and the printer 1. The CPU 62 is a processing unit for controlling the entire printer. The memory 63 is for securing a work area and an area for storing programs of the CPU 62, for example, and has storage devices such as a RAM or an EEPROM. The CPU 62 controls each of the units via the unit control circuit 64 in accordance with programs stored in the memory 63.

Regarding Nozzles

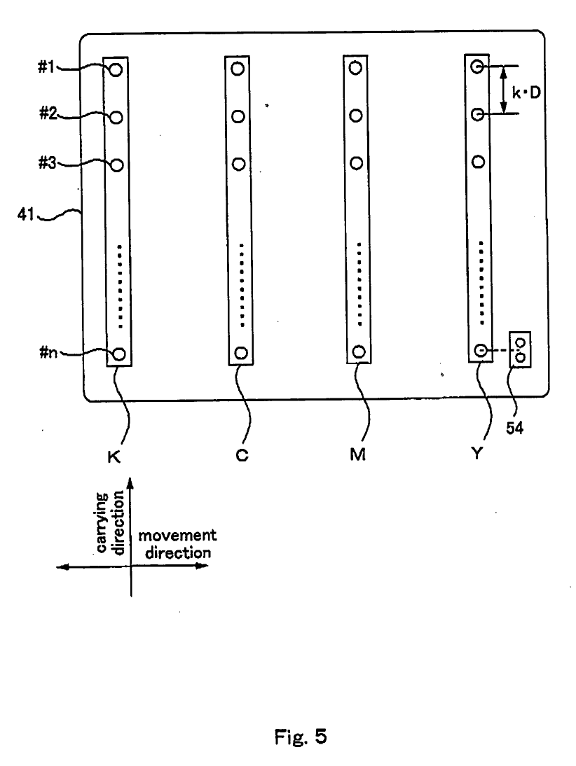

FIG. 5 is an explanatory diagram illustrating the arrangement of nozzles on a lower face of the head 41. A black ink nozzle group K, a cyan ink nozzle group C, a magenta ink nozzle group M, and a yellow ink nozzle group Y are formed on the lower face of the head 41. Each nozzle group is provided with a plurality of nozzles (in this embodiment, 180 nozzles), which are ejection openings for ejecting ink of each color.

A plurality of the nozzles of each nozzle group are arranged in rows at a constant spacing (nozzle pitch: k·D) in the carrying direction. Here, D is the minimum dot pitch (that is, the spacing at the maximum resolution of dots formed on the paper S) in the carrying direction. Further, k is an integer of one or more. For example, if the nozzle pitch is 180 dpi ( 1/180 inch) and the dot pitch in the carrying direction is 720 dpi ( 1/720 inch), then k=4.

The nozzles of each nozzle group are assigned numbers (#1 to #180) that become smaller as the nozzles is arranged more downstream. More specifically, the nozzle #1 is positioned on the further downstream side in the carrying direction than the nozzle #180. It should be noted that the optical sensor 54 described above is provided at substantially the same position as the nozzle #180, which is positioned on the furthest upstream side in the carrying direction.

Each nozzle is provided with an ink chamber (not shown) and a piezo element. Driving the piezo element causes the ink chamber to constrict and expand, thereby ejecting an ink droplet from the nozzle.

Regarding Printing Operation

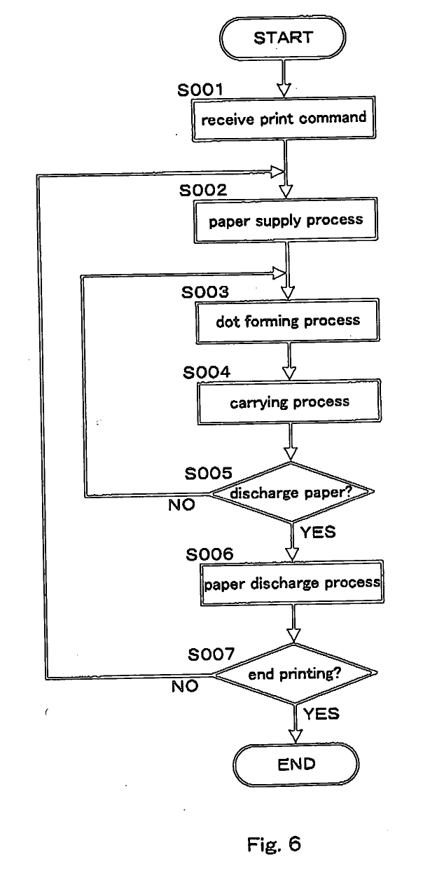

FIG. 6 is a flowchart of the processes during printing. The processes described below are performed by the controller 60 controlling the units in accordance with a program stored in the memory 63. This program has codes for executing the processes.

Print Command Reception (S001) First, the controller 60 receives a print command from the computer 110 via the interface section 61. This print command is included in the header of the print data transmitted from the computer 110. The controller 60 then analyzes the content of the various commands included in the print data that has been received, and performs processes such as a paper supply process, a carrying process, and a dot forming process described below, using the units.

Paper Supply Process (S002): The paper supply process is a process in which paper to be printed is supplied into the printer and the paper is positioned at a print start position (also referred to as an “initial position” or an “indexing position”). The controller 60 rotates the paper supply roller 21 to send the paper to be printed to the carry roller 23. Next, the controller 60 rotates the carry roller 23 to carry the paper that has been sent from the paper supply roller 21 to the print start position. When the paper has been carried to the print start position (when the paper is supplied), at least a part of the nozzles of the head 41 is opposed to the paper.

Dot Forming Process (S003): The dot forming process is a process in which dots are formed on the paper by letting ink be intermittently ejected from the head that moves in the movement direction. The controller 60 moves the carriage 31 in the movement direction by driving the carriage motor 32. The controller 60 then causes the head to eject ink based on the print data while the carriage 31 is moving. Dots are formed on the paper when ink droplets ejected from the head 41 land on the paper. Since ink is intermittently ejected from the moving head 41, dot rows (raster lines) constituted by a plurality of dots in the movement direction are formed on the paper.

Carrying Process (S004): The carrying process is a process in which the paper is moved relative to the head in the carrying direction. The controller 60 carries the paper in the carrying direction by driving the carry motor and rotating the carry roller. Through this carrying process, the head 41 can form dots at the positions that are different from the positions of the dots formed in the preceding dot forming process.

Paper Discharge Determination (S005): The controller 60 determines whether or not to discharge the paper that is being printed. If there is data left to be printed on the paper that is being printed, then the paper is not discharged. The controller 60 repeats the dot forming process and the carrying processes alternately until there is no more data to be printed, gradually printing on the paper an image constituted by dots.

Paper Discharge Process (S006): If there is no more data to be printed on the paper that is being printed, then the controller 60 discharges that paper by rotating the paper discharge roller. It should be noted that whether or not to discharge the paper can also be determined based on a paper discharge command included in the print data.

Print End Determination (S007): Next, the controller 60 determines whether or not to continue printing. If the following paper is to be printed, then printing is continued and the paper supply process for the following paper is started. If printing is not performed on the following paper, then the printing operation is ended.

Basic Print Mode

Next, basic print modes applied by the printer are described. Hereinafter, as the basic print modes, band printing, overlap printing, interlaced printing, and full overlap printing are described.

Regarding Band Printing

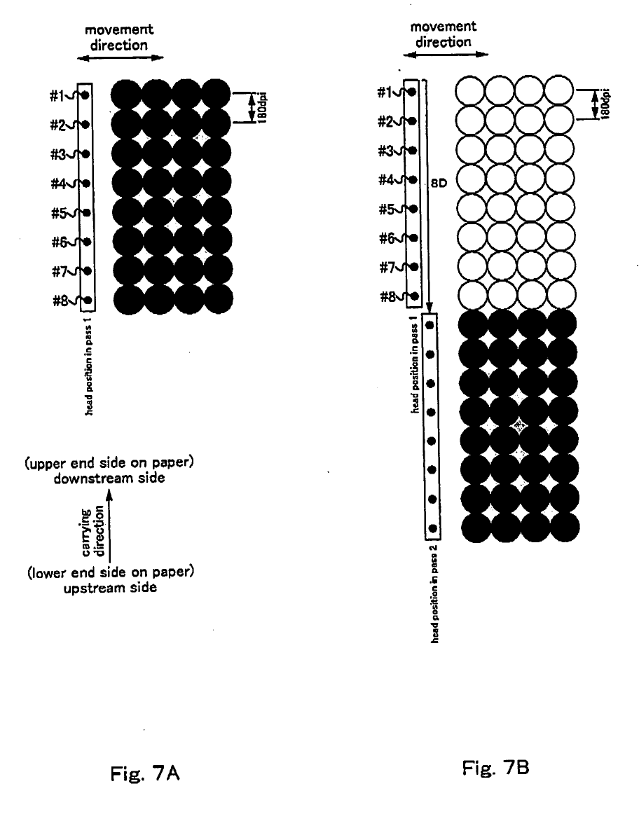

FIGS. 7A and 7B are explanatory diagrams of band printing. FIG. 7A shows the position of the head (or nozzles) in a single pass and the manner in which dots are formed in the single pass. FIG. 7B shows the position of the head in a next pass and the manner in which dots are formed in the next pass.

For the sake of convenience, only one nozzle group of a plurality of the nozzle groups is shown, and the number of nozzles in that nozzle group has been reduced (in this case, to eight nozzles). The nozzles indicated by black circles in the drawings are nozzles that can eject ink. Again, for the sake of convenience, the head (or nozzle group) is shown moving with respect to the paper, but the drawings show the relative position between the head and the paper, and in practice, it is the paper that moves in the carrying direction. Further, for the sake of convenience, the nozzles are shown forming only several dots (circles in the drawing), but in practice, ink droplets are intermittently ejected from the nozzles that are moving in the movement direction, and thus a large number of dots are aligned in the movement direction. These rows of dots are also referred to as raster lines. The dots indicated by black circles are dots that are formed in the latest pass, and the dots indicated by white circles are dots that are formed in the preceding passes. It should be noted that a “pass” refers to an operation of forming dots (dot forming operation) by ejecting ink from the moving nozzles. Each pass is performed alternately with an operation of carrying the paper in the carrying direction (carrying operation).

The “band printing” refers to a printing method by which consecutive raster lines are formed in a single pass. More specifically, in the band printing, an image fragment in a band shape that is as long as the length of a nozzle row is formed in a single pass. In the carrying operation that is performed between the passes, the paper is carried by the length of the nozzle row (8D in this case). By repeating alternately the pass and the carrying operation, the image fragments in a band shape are joined to one another in the carrying direction, forming the print image.

In the band printing, the dot spacing D in the carrying direction is the same as the nozzle pitch, and is 180 dpi in this embodiment. It should be noted that if the number of nozzles is 180, then the carry amount is 180 D.

Overlap Printing

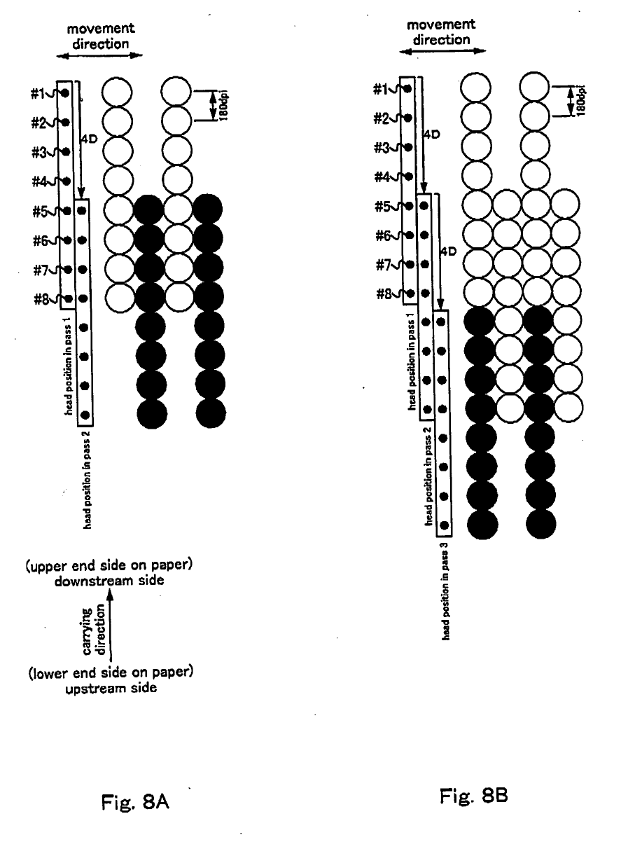

FIGS. 8A and 8B are explanatory diagrams of overlap printing. FIG. 8A shows the positions of the head in pass 1 and pass 2 and the manner in which dots are formed in pass 1 and pass 2. FIG. 8B shows the positions of the head in pass 1 to pass 3 and the manner in which dots are formed in pass 1 to pass 3.

The “overlap printing” refers to a printing method by which each raster line is formed by a plurality of the nozzles. For example, in the overlap printing in the drawings, each raster line is formed by two nozzles.

In the overlap printing, each nozzle forms dots at every other dot in each pass. Then, in another pass, another nozzle forms dots so as to fill in spaces between the dots. For example, in the overlap printing in the drawings, the nozzle #5 to the nozzle #8 form dots at every other dot in a certain pass, and the nozzle #1 to the nozzle #4 form dots so as to fill in spaces between the dots in the next pass. In the carrying operation that is performed between the passes, paper is carried by a carry amount of 4 D, which is half the amount in the band printing described above. It should be noted that if the number of nozzles is 180, then the carry amount is 90 D.

Herein, in the band printing, each raster line is formed by one nozzle. Thus, if the flying direction of ink droplets is disordered due to the influence of manufacturing differences or the like, the position of all dots constituting a raster line that is formed by the nozzle is disordered, and thus a striped pattern appears in a print image.

On the other hand, in the overlap printing, one raster line is formed by two nozzles, and thus even if the flying direction of ink droplets from one nozzle is disordered, the influence on the raster line is reduced. Thus, in general, it is possible to perform printing at a higher image quality in the overlap printing than in the band printing.

Interlaced Printing

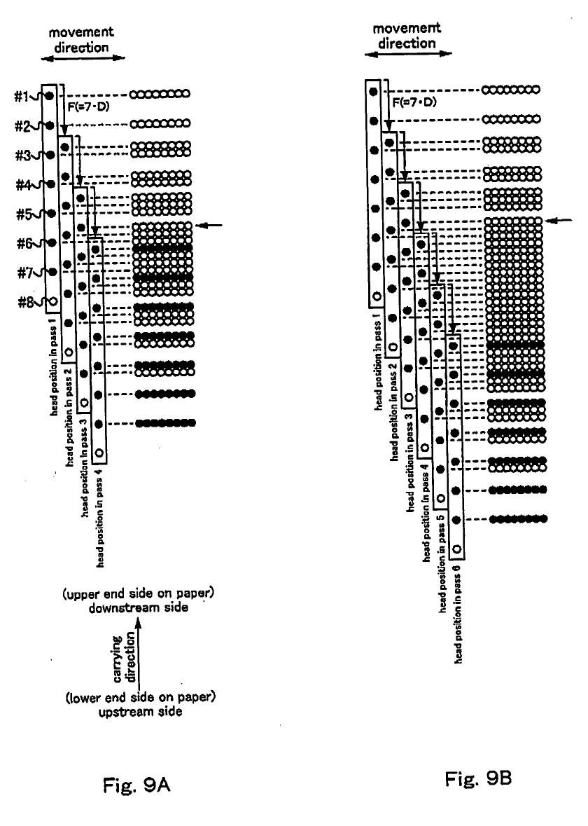

FIGS. 9A and 9B are explanatory diagrams of interlaced printing. FIG. 9A shows the positions of the head (or nozzle group) in pass 1 to pass 4 and the manner in which dots are formed in pass 1 to pass 4. FIG. 9B shows the positions of the head in pass 1 to pass 6 and the manner in which dots are formed in pass 1 to pass 6. It should be noted that the nozzles indicated by black circles in the drawings are nozzles that can eject ink, and the nozzles indicated by white circles are nozzles that cannot eject ink.

The “interlaced printing” refers to a printing method by which k is two or larger and a raster line that is not recorded are interposed by raster lines that are recorded in a single pass. For example, in the printing method shown in FIGS. 9A and 9B, three raster lines are interposed between raster lines that are formed by a single pass.

In the interlaced printing, paper is carried repeatedly by a constant carry amount F in the carrying direction. The following conditions are necessary in order to perform recording in this manner by a constant carry amount: (1) the number N (integer) of nozzles that can eject ink and k are coprime, and (2) the carry amount F is set to N·D.

In FIGS. 9A and 9B, the nozzle group has eight nozzles arranged long the carrying direction. The nozzle pitch k of the nozzle group is 4. Thus, in order to satisfy the condition that “N and k are coprime” for performing the interlaced printing, not all of the nozzles are used, but seven nozzles (the nozzle #1 to the nozzle #7) are used. Furthermore, because seven nozzles are used, paper is carried by a carry amount of 7·D. As a result, using the nozzle group with a nozzle pitch of 180 dpi (4·D), dots are formed on the paper with a dot spacing of 720 dpi (=D). It should be noted that if the number of nozzles is 180, then 179 nozzles can eject ink, and the carry amount is set to 179 D.

Full Overlap Printing

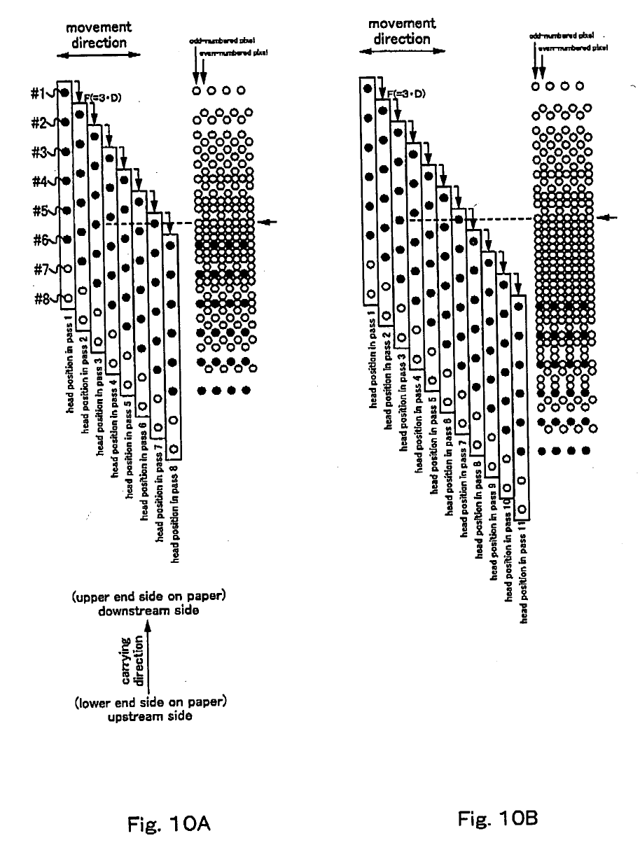

FIGS. 10A and 10B are explanatory diagrams of full overlap printing. FIG. 10A shows the positions of the head in pass 1 to pass 8 and the manner in which dots are formed in pass 1 to pass 8. FIG. 10B shows the positions of the head in pass 1 to pass 11 and the manner in which dots are formed in pass 1 to pass 11.

The “full overlap printing” refers to a printing method by which k is two or larger and each raster line is formed by a plurality of the nozzles. For example, in the full overlap printing of the drawings, each raster line is formed by two nozzles.

In the full overlap printing, each time the paper is carried by a constant carry amount F in the carrying direction, each nozzle forms dots intermittently at every several dots. Then, in another pass, another nozzle forms dots so as to complement the intermittent dots (fill in the spaces between dots) that have already been formed, and thus a single raster line is formed by a plurality of the nozzles. Forming a single raster line in this manner in M passes is defined as the “overlap number M”.

In FIGS. 10A and 10B, since each nozzle forms dots intermittently at every other dot, dots are formed in every pass either at the odd-numbered pixels or at the even-numbered pixels. Since a single raster line is formed by two nozzles, the overlap number M is 2.

In the full overlap printing, the following conditions are necessary in order to perform recording by a constant carry amount: (1) N/M is an integer, (2) N/M and k are coprime, and (3) the carry amount F is set to (N/M)·D.

In FIGS. 10A and 10B, the nozzle group has eight nozzles arranged along the carrying direction. However, the nozzle pitch k of the nozzle group is 4. Thus, in order to satisfy the condition that “N/M and k are coprime” for performing the full overlap printing, not all the nozzles can be used. Therefore, six of the eight nozzles are used to perform the full overlap printing. Furthermore, since six nozzles are used, paper is carried by a carry amount of 3·D. As a result, using the nozzle group with a nozzle pitch of 180 dpi (4·D) for example, dots are formed on the paper with a dot spacing of 720 dpi (=D). It should be noted that if the number of nozzles is 180, then 178 nozzles can eject ink and the carry amount is set to 89 D.

In FIGS. 10A and 10B, in pass 1 the nozzles form dots in odd-numbered pixels, in pass 2 the nozzles form dots in even-numbered pixels, in pass 3 the nozzles form dots in odd-numbered pixels, and in pass 4 the nozzles form dots in even-numbered pixels. More specifically, in these first four passes, dots are formed in the order of odd-numbered pixel, even-numbered pixel, odd-numbered pixel, and then even-numbered pixel. Subsequently, in the next four passes (pass 5 to pass 8), dots are formed in the opposite order to that in the first four passes, in the order of even-numbered pixel, odd-numbered pixel, even-numbered pixel, and then odd-numbered pixel. It should be noted that from pass 9 onward, dots are formed in the same order as that in pass 1 onward.

Herein, in the interlaced printing, each raster line is formed by one nozzle. Thus, if the flying direction of ink droplets is disordered due to the influence of manufacturing differences or the like, the position of all dots constituting a raster line that is formed by the nozzle is disordered, and thus a striped pattern appears in a print image.

On the other hand, in the full overlap printing, one raster line is formed by two nozzles, and thus even if the flying direction of ink droplets from one nozzle is disordered, the influence on the raster line is reduced. Thus, in general, it is possible to perform printing at a higher image quality in the full overlap printing than in the interlaced printing.

### The First Embodiment

Regarding Partial Deterioration in Image Quality in Vicinity of Lower End

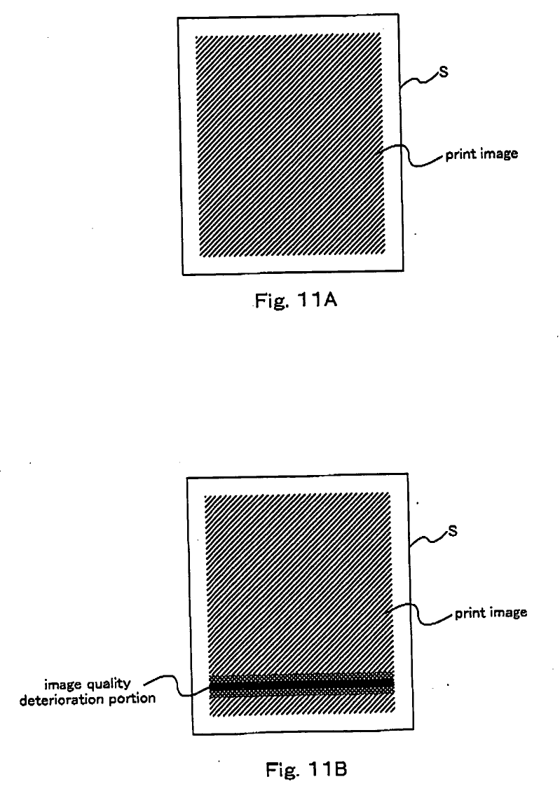

FIG. 11A is an explanatory diagram of a state in which a print image is properly formed on paper. Herein, for the sake of convenience, a print image is shown as an image with a constant density. FIG. 11B is an explanatory diagram of a state in which the image quality of a print image is partially deteriorated by being affected by a lower end passing the carry roller . Although an image with a constant density should have been printed, the image quality of the print image is disturbed, and density unevenness in a band shape in the carriage movement direction is formed.

Next, the factors causing such density unevenness are described.

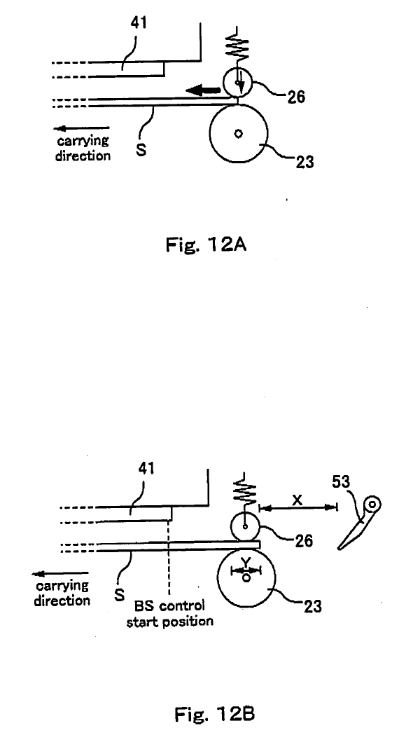

FIG. 12A is an explanatory view of a state in which a lower end of paper S is held between the carry roller 23 and the first driven roller 26. In order to hold the paper S, a spring force is applied to the first driven roller 26 toward the carry roller 23. Due to the influence of this spring force, when the lower end of the paper S is held between the carry roller 23 and the first driven roller 26, a force in the carrying direction is applied to the paper S such that the lower end of the paper S is smoothly moved apart from the two rollers. This force becomes greater as the carry speed of the paper S is higher (as the rotational speed of the carry roller 23 is higher) at a time when the lower end of the paper S is positioned between the carry roller 23 and the first driven roller 26.

When such a force is applied to the paper S during printing, the position of the paper S with respect to the head 41 is displaced, and thus the position of dots formed in the dot forming process is displaced in the carrying direction, so that the image quality of that portion in the print image is deteriorated. More specifically, in this case, density unevenness in a band shape as shown in FIG. 11B is formed.

Thus, a process called BS control is performed when the lower end of the paper S passes the carry roller 23.

FIG. 12B is an explanatory view of a state at the time of starting BS control. After the paper detection sensor 53 detects that the lower end of the paper S has passed the position of the paper detection sensor 53, the controller 60 performs the carrying process in an ordinary manner until the carry amount reaches X. When the carry amount reaches X, the lower end of the paper S is about to reach the position between the carry roller 23 and the first driven roller 26. If the ordinary carrying process is performed without any processing, then when the paper S passes the carry roller 23, a force in the carrying direction is applied to the paper S such that the lower end of the paper S is smoothly moved apart from the two rollers. Thus, the controller 60 makes the carry speed of the paper S low after the carry amount has reached X. Then, while the lower end of the paper S is positioned in a zone Y, that is, until the lower end of the paper S passes the carry roller 23, the controller 60 makes the carry speed of the paper S low. This process is referred to as BS control.

It should be noted that in the state shown in FIG. 12B (state in which after the paper detection sensor 53 detects that the lower end of the paper S has passed the position of the paper detection sensor 53, the carry amount reaches X), the position on the paper opposed to the nozzle on the most upstream side on the head 41 in the carrying direction is referred to as a “BS control start position”. After the lower end of the paper S has passed the zone Y, the controller 60 performs the ordinary carrying process.

It is possible to suppress displacement of the position of the paper S with respect to the head 41 by performing this BS control.

However, even if the BS control is performed, when the lower end of the paper S passes the carry roller 23, the position of the paper S with respect to the head 41 is displaced to some extent. More specifically, even if the BS control is performed, density unevenness in a band shape as shown in FIG. 11B may be formed.

Thus, it is conceivable that such an image quality deterioration portion is printed by a print mode that can form a print image at a high image quality. As such a printing method, there are conceivable a first method in which the band printing is performed in an ordinary print area and the overlap printing is performed in an image quality deterioration portion, and a second method in which the interlaced printing is performed in an ordinary print area and the full overlap printing is performed in an image quality deterioration portion. In both of the printing methods, a raster line is formed by one nozzle in an ordinary print area, and a raster line is formed by two nozzles in an image quality deterioration portion. Hereinafter, these printing methods are described.

Regarding First Printing Method

In a Case Where the Number of Nozzles is Eight

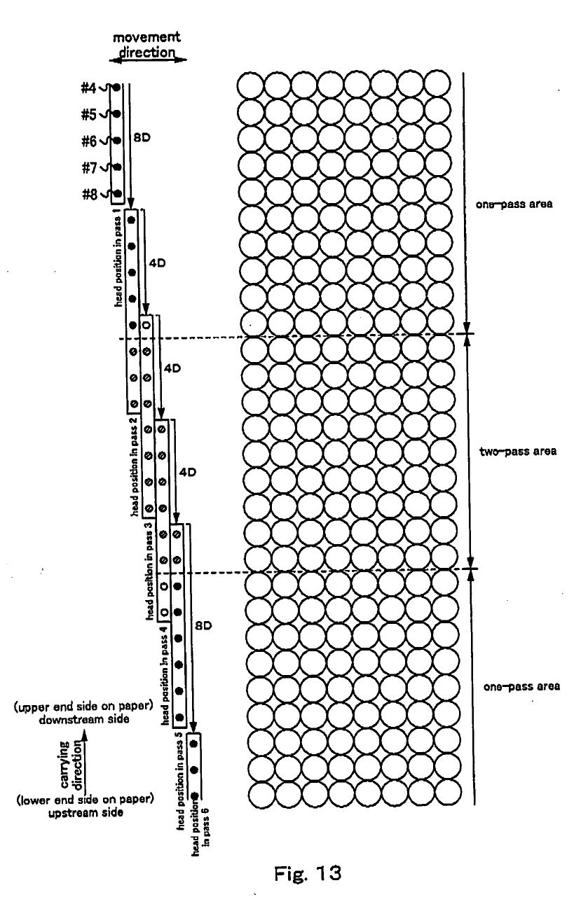

FIG. 13 is an explanatory diagram of the first printing method. Herein, for the sake of convenience, a description is made taking the number of nozzles as eight. In the drawing, the hatched nozzles are nozzles that form dots at every other dot. As will be clear in the description below, a “one-pass area” in the drawing is formed by the band printing described above, and a “two-pass area” is formed by the overlap printing described above. In other words, raster lines in the “one-pass area” in the drawing are formed in a single pass, and raster lines in the “two-pass area” are formed in two passes.

Before pass 2, raster lines are formed by the band printing described above. More specifically, the nozzle #1 to the nozzle #8 form raster lines in a single pass, and the carrying process by a carry amount of 8 D is performed between the passes.

The carrying process by a carry amount of 8 D is performed between pass 1 and pass 2 as in the band printing described above. However, in pass 2, ink ejection differs depending on the nozzle. The nozzles positioned in the “one-pass area” form raster lines in a single pass as in the band printing described above. For example, the nozzle #5 in pass 2 forms a raster line in a single pass as in the band printing described above. Accordingly, the raster lines in the “one-pass area” on the upper side in the drawing are formed by the band printing. On the other hand, the nozzles positioned in the “two-pass area” form dots at every other dot as in the overlap printing described above. For example, the nozzle #6 in pass 2 forms dots at every other dot.

The carrying process by a carry amount of 4 D is performed as in the overlap printing described above between the passes from pass 2 to pass 5. However, in these passes, ink ejection differs depending on the nozzle. For example, in pass 3, the nozzle #1 positioned in the “one-pass area” does not eject ink, and the nozzle #2 to the nozzle #8 positioned in the “two-pass area” form dots at every other dot. In pass 4, the nozzle #1 to the nozzle #6 positioned in the “two-pass area” form dots at every other dot, and the nozzle #7 and the nozzle #8 positioned in the “one-pass area” do not eject ink. In pass 5, the nozzle #1 and the nozzle #2 positioned in the “two-pass area” form dots at every other dot, and the nozzle #3 to the nozzle #8 positioned in the “one-pass area” form raster lines in a single pass. Accordingly, the raster lines in the “two-pass area” in the drawing are formed by the overlap printing.

From pass 5 onward, the carrying process by a carry amount of 8 D is performed as in the band printing described above. Then, from pass 6 onward, raster lines are formed by the band printing described above. More specifically, the nozzle #1 to the nozzle #8 form raster lines in a single pass, and the carrying process by a carry amount of 8 D is performed between the passes. Accordingly, the raster lines in the “one-pass area” on the lower side in the drawing are formed by the band printing.

According to this embodiment, in the two-pass area, each raster line is formed by two nozzles. Thus, even if the position of the paper with respect to the head is displaced and thus dots formed by one nozzle among the two nozzles forming a raster line are displaced, the influence on the raster line is reduced.

In a Case Where the Number of Nozzles is 180

In the description above, for the sake of convenience, the number of nozzles was taken as eight, but in practice, 180 nozzles (nozzle #1 to nozzle #180) are provided in each of the nozzle groups of the respective colors. Furthermore, in the description above, the two-pass area was narrow (for nine raster lines). Thus, a description is made taking the number of nozzles as 180 and making the “two-pass area” wider.

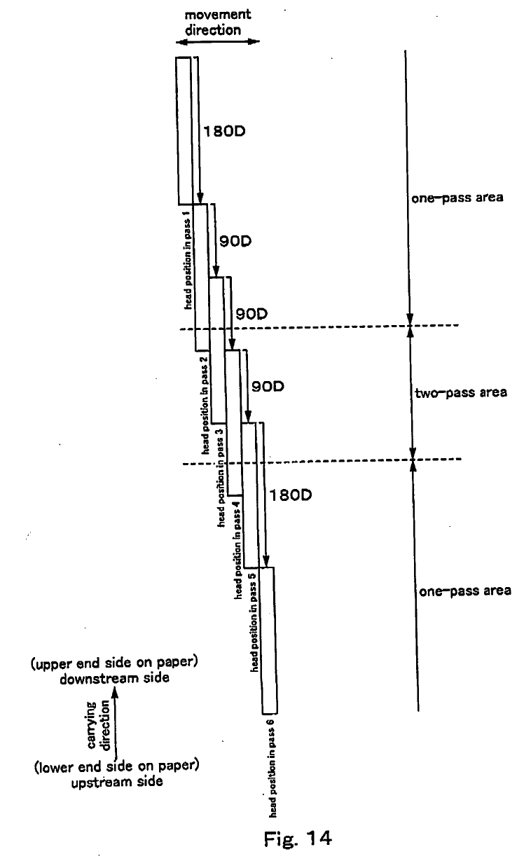

FIG. 14 is an explanatory diagram of the first printing method. The two-pass area is set at a predetermined position (such as an image quality deterioration portion) on the paper.

Before pass 2, raster lines are formed by the band printing. More specifically, before printing of the “two-pass area”, raster lines are formed by the band printing. In this case, the nozzle #1 to the nozzle #180 form raster lines in a single pass, and the carrying process by a carry amount of 180 D is performed between the passes.

In the carrying process between pass 1 and pass 2, the nozzle #180 that is a nozzle on the most upstream side in the carrying direction enters the “two-pass area”. In other words, printing of the “two-pass area” is started from pass 2 onward. In pass 2, ink ejection differs depending on the nozzle. The nozzles positioned in the “one-pass area” form raster lines in a single pass as in the band printing described above. Accordingly, the raster lines in the “one-pass area” on the upper side in the drawing are formed by the band printing. On the other hand, the nozzles positioned in the “two-pass area” form dots at every other dot as in the overlap printing described above.

The carrying process by a carry amount of 90 D is performed as in the overlap printing described above between the passes from pass 2 to pass 5. However, in these passes, ink ejection differs depending on the nozzle. For example, in pass 3 and pass 4, the nozzles positioned in the “two-pass area” form dots at every other dot, and the nozzles positioned in the “one-pass area” do not eject ink. Furthermore, in pass 5, the nozzles positioned in the “two-pass area” form dots at every other dot, and the nozzles positioned in the “one-pass area” form raster lines in a single pass. Accordingly, the raster lines in the “two-pass area” in the drawing are formed by the overlap printing.

From pass 5 onward, the carrying process by a carry amount of 180 D is performed as in the band printing described above. Then, from pass 6 onward, raster lines are formed by the band printing. Accordingly, the raster lines in the “one-pass area” on the lower side in the drawing are formed by the band printing.

According to this embodiment, in the two-pass area, each raster line is formed by two nozzles. Thus, even if the position of the paper with respect to the head is displaced and thus dots formed by one nozzle among the two nozzles forming a raster line are displaced, the influence on the raster line is reduced.

Regarding Second Printing Method

In a Case Where the Number of Nozzles is Eight

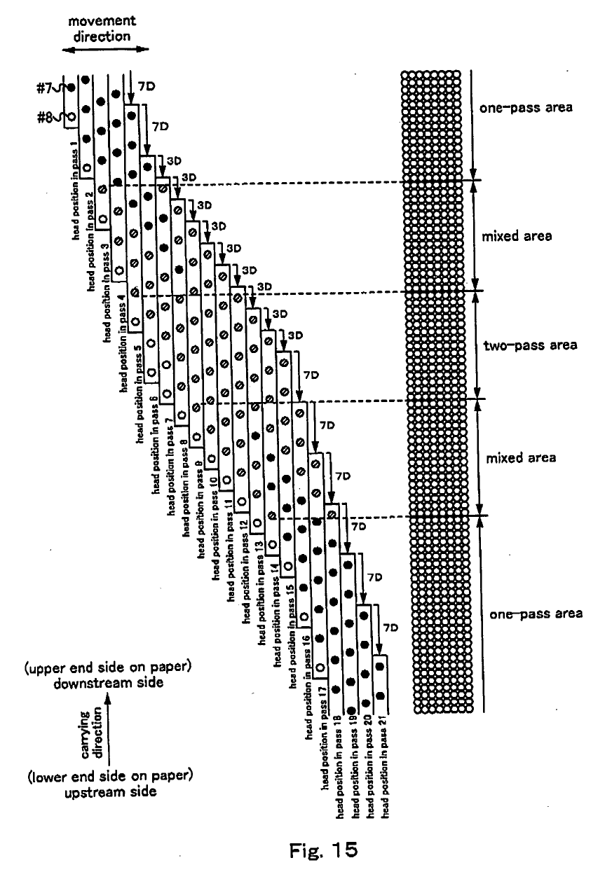

FIG. 15 is an explanatory diagram of the second printing method. Herein, for the sake of convenience, a description is made taking the number of nozzles as eight. In the drawing, the hatched nozzles are nozzles that form dots at every other dot. As will be clear in the description below, in this embodiment, a “one-pass area” is formed by the interlaced printing described above, and a “two-pass area” is formed by the full overlap printing described above. More specifically, raster lines in the “one-pass area” are formed in a single pass, and raster lines in the “two-pass area” are formed in two passes.

Before pass 2, raster lines are formed by the interlaced printing described above. More specifically, the nozzle #1 to the nozzle #7 form raster lines in a single pass, and the carrying process by a carry amount of 7 D is performed between the passes.

The carrying process by a carry amount of 7 D is performed as in the interlaced printing described above between the passes from pass 3 to pass 6. However, in these passes, ink ejection differs depending on the nozzle. The nozzles positioned on the downstream side in the carrying direction with respect to a predetermined position (position on a dotted line as the boundary between a “one-pass area” and a “mixed area” on the upper side in the drawing) on the paper form raster lines as in the interlaced printing described above. For example, the nozzle #5 in pass 4 forms a raster line in a single pass as in the interlaced printing described above. Accordingly, the raster lines in the “one-pass area” on the upper side in the drawing are formed by the interlaced printing on the other hand, the nozzles positioned on the upstream side in the carrying direction with respect to this position (position on the dotted line as the boundary between the “one-pass area” and the “mixed area” on the upper side in the drawing) form dots at every other dot if the position thereof (position in the carrying direction with respect to paper) matches the position of any nozzle in any pass from pass 7 onward in the carrying direction, or form raster lines in a single pass if there is no matching nozzle. For example, the position of the nozzle #7 in pass 3 matches the position of the nozzle #1 in pass 7 in the carrying direction, and thus dots are formed at every other dot. On the other hand, the position of the nozzle #4 in pass 5 does not match the position of any nozzle in any pass from pass 7 onward in the carrying direction, and thus a raster line is formed in a single pass.

The carrying process by a carry amount of 3 D is performed as in the full overlap printing described above between the passes from pass 6 to pass 15. However, in these passes, ink ejection differs depending on the nozzle. The nozzles positioned in a predetermined range (range of the “two-pass area” in the drawing) on the paper form dots at every other dot as in the full overlap printing described above. For example, the nozzle #6 in pass 6 forms dots at every other dot. Accordingly, the raster lines in the “two-pass area” in the drawing are formed by the full overlap printing. On the other hand, the nozzles outside this range form dots at every other dot if the position thereof matches the position of any nozzle in another pass in the carrying direction, or forms raster lines in a single pass if there is no matching nozzle. For example, the position of the nozzle #4 in pass 6 matches the position of the nozzle #1 in pass 10 in the carrying direction, and thus dots are formed at every other dot. On the other hand, the position of the nozzle #3 in pass 6 does not match the position of any nozzle in any pass in the carrying direction, and thus a raster line is formed in a single pass.

According to this embodiment, in the “two-pass area”, each raster line iS formed by two nozzles. Thus, even if the position of the paper with respect to the head is displaced and thus dots formed by one nozzle among the two nozzles forming a raster line are displaced, the influence on the raster line is reduced.

Furthermore, according to this embodiment, the “mixed area” is formed between the “one-pass area” and the “two-pass area”. In the “mixed area”, raster lines formed in a single pass and raster lines formed in two passes are present in a mixed state. In other words, in the area between the “one-pass area” and the “two-pass area” on the upper side in the drawing, raster lines formed by one nozzle and raster lines formed by two nozzles are present in a mixed state. When this “mixed area” is formed between the “one-pass area” and the “two-pass area”, change in the image quality from the “one-pass area” to the “two-pass area” becomes moderate, and thus the difference in the image quality between the “one-pass area” and the “two-pass area” becomes less remarkable. As a result, it is possible to improve the image quality in the “two-pass area” and to suppress deterioration of the image quality of the entire print image.

Furthermore, according to this embodiment, many raster lines are formed in a single pass on the side close to the “one-pass area” in the “mixed area”. On the other hand, many raster lines are formed in two passes on the side close to the “two-pass area” in the “mixed area”. More specifically, there are fifteen raster lines in the “mixed area”, and of these, six raster lines are formed in a single pass and nine raster lines are formed in two passes. Of seven raster lines positioned close to the “one-pass area” in the “mixed area”, four raster lines are formed in a single pass, and more than half the raster lines formed in a single pass in the “mixed area” are present on the side close to the “one-pass area”.

Accordingly, even in the same “mixed area”, the image quality close to that in the interlaced printing is obtained on the side close to the “one-pass area”, and the image quality close to that in the full overlap printing is obtained on the side close to the “two-pass area”. When the “mixed area” having this image quality is formed between the “one-pass area” and the “two-pass area”, change in the image quality from the “one-pass area” to the “two-pass area” becomes very moderate, and thus the difference in the image quality between the “one-pass area” and the “two-pass area” becomes less remarkable. As a result, it is possible to improve the image quality in the “two-pass area” and to suppress deterioration of the image quality of the entire print image.

Although a description on the process from pass 16 onward has been omitted, the “mixed area” is formed between the “one-pass area” and the “two-pass area” also on the lower side in the drawing. Furthermore, also in this case, many raster lines are formed in a single pass on the side close to the “one-pass area” in the “mixed area”, and many raster lines are formed in two passes on the side close to the “two-pass area” in the “mixed area”. Accordingly, also on the lower side in the drawing, the difference in the image quality between the “one-pass area” and the “two-pass area” becomes less remarkable, and as a result, it is possible to suppress deterioration of the image quality of the entire print image.

In a Case Where the Number of Nozzles is 180

In the description above, for the sake of convenience, the number of nozzles was taken as eight, but in practice, 180 nozzles (nozzle #1 to nozzle #180) are provided in each of the nozzle groups of the respective colors. Furthermore, in the description above, the mixed area was narrow, and thus there is a pass in which raster lines are formed in three areas such as the one-pass area, the mixed area, and the two-pass area (pass 6 in FIG. 15, for example). Thus, a description is made taking the number of nozzles as 180 and making the mixed area have the head width (=carry amount×k×M: length of the nozzle row).

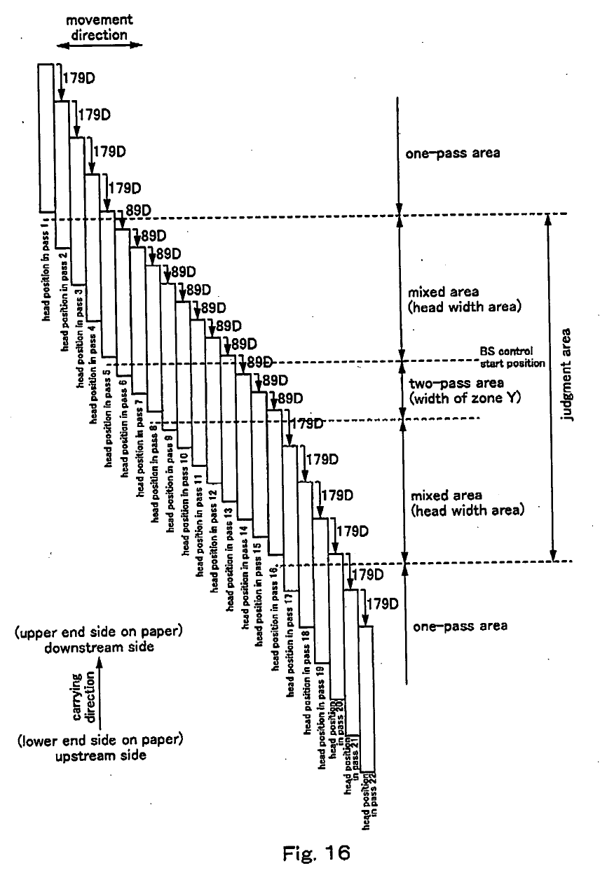

FIG. 16 is an explanatory diagram of the second printing method. The two-pass area is set at a predetermined position (such as an image quality deterioration portion) on the paper. Then, the two-pass area and two areas of the head widths on the upstream side and on the downstream side of that two-pass area in the carrying direction are set as a judgment area as a whole.

Before pass 2, raster lines are formed by the interlaced printing. More specifically, before printing the judgment area, raster lines are formed by the interlaced printing. In this case, the nozzle #1 to the nozzle #179 form raster lines in a single pass, and the carrying process by a carry amount of 179 D is performed between the passes.

In the carrying process between pass 1 and pass 2, the nozzle #179 that is a nozzle for ejecting ink on the most upstream side in the carrying direction enters the judgment area. Then, up to pass 5 that is the fourth pass (=k×M) including pass 2 immediately after this carrying process, the carrying process is performed by a carry amount of 179 D, which is a carry amount in the interlaced printing.

From pass 2 to pass 5, ink ejection differs depending on the nozzle. The nozzles positioned on the downstream side in the carrying direction outside the judgment area form raster lines in a single pass as in the interlaced printing. Accordingly, the raster lines in the “one-pass area” in the drawing are formed by the interlaced printing. On the other hand, the nozzles within the judgment area form dots at every other dot if the position thereof (position in the carrying direction with respect to the paper) matches the position of any nozzle in any pass from pass 6 onward in the carrying direction, or form raster lines in a single pass if there is no matching nozzle.

In the carrying process between pass 5 and pass 6, the nozzle #179 that is a nozzle for ejecting ink on the most upstream side in the carrying direction enters the two-pass area. Then, to pass 16 where the nozzle #1 that is a nozzle for ejecting ink on the most downstream side in the carrying direction is about to pass the two-pass area, the carrying process is performed by a carry amount of 89 D, which is a carry amount in the full overlap printing.

From pass 6 to pass 16, ink ejection differs depending on the nozzle. The nozzles positioned in the two-pass area form dots at every other dot as in the full overlap printing described above (however, the nozzle #179 and the nozzle #180 do not eject ink). Accordingly, the raster lines in the “two-pass area” in the drawing are formed in the full overlap printing. On the other hand, the nozzles outside the two-pass area (nozzles in the mixed area) form dots at every other dot if the position thereof matches the position of any nozzle in another pass in the carrying direction, or form raster lines in a single pass if there is no matching nozzle.

In the carrying process between pass 16 and pass 17, the nozzle #1 that is a nozzle for ejecting ink on the most downstream side in the carrying direction passes the two-pass area. Thus, from this carrying process, the carrying process is performed by a carry amount of 179 D, which is a carry amount in the interlaced printing. It should be noted that after this carrying process, the nozzle #179 that is a nozzle for ejecting ink on the most upstream side in the carrying direction passes the judgment area.

From pass 17 to pass 20, ink ejection differs depending on the nozzle. The nozzles positioned on the upstream side in the carrying direction outside the judgment area form raster lines in a single pass as in the interlaced printing. On the other hand, the nozzles within the judgment area form dots at every other dot if the position thereof matches the position of any nozzle in another pass in the carrying direction, or form raster lines in a single pass if there is no matching nozzle.

According to this embodiment, the “mixed area” is formed between the “one-pass area” and the “two-pass area” as in the simplified embodiment described above. Furthermore, also in this case, many raster lines are formed in a single pass on the side close to the “one-pass area” in the “mixed area”, and many raster lines are formed in two passes on the side close to the “two-pass area” in the “mixed area”. Thus, also on the lower side in the drawing, the difference in the image quality between the “one-pass area” and the “two-pass area” becomes less remarkable, and thus it is possible to suppress deterioration of the image quality of the entire print image.

Furthermore, in this embodiment, the boundary of the two-pass area on the downstream side in the carrying direction is set to the “BS control start position” (see FIG. 12B). Thus, before the nozzle on the most upstream side in the carrying direction enters the two-pass area, the lower end of the paper has not passed the carry roller 23 yet. In this embodiment, at (or before) the moment the nozzle on the most upstream side in the carrying direction enters the two-pass area, printing in the overlap printing is started. More specifically, in FIG. 16, as the carrying process between pass 5 and pass 6, the carrying process in the overlap printing is performed, and printing in the overlap printing is started at a part of the nozzles from pass 6 onward. Accordingly, the overlap printing is started before the lower end of the paper has passed the carry roller 23, and it is possible to print the image quality deterioration portion in a print mode with a high image quality.

Furthermore, in this embodiment, the boundary of the two-pass area on the upstream side in the carrying direction is set such that the width of the two-pass area is the same as the width of the zone Y in FIG. 12B (thus, when the boundary of the two-pass area on the upstream side in the carrying direction is opposed to the nozzle #179 on the most upstream side in the carrying direction, the lower end of the paper has already passed the carry roller). Thus, when the nozzle on the most upstream side in the carrying direction passes the two-pass area, the lower end of the paper has already passed the carry roller 23. Furthermore, in this embodiment, after the nozzle #1 on the most downstream side in the carrying direction has passed the two-pass area, printing in the overlap printing is cancelled and the print mode is returned to the interlaced printing. More specifically, in FIG. 16, as the carrying process between pass 16 and pass 17, the carrying process in the interlaced printing is performed, and printing in the interlaced printing is started at a part of the nozzles from pass 17 onward. Thus, it is possible to make the print speed faster than in a case where the overlap printing is continued. Furthermore, even when the print mode is returned to the interlaced printing at this point, printing of the image quality deterioration portion has ended, and thus deterioration of the image quality does not cause a problem.

### Regarding Paper Supply Process in the First Embodiment

In the Case of a Comparative Example

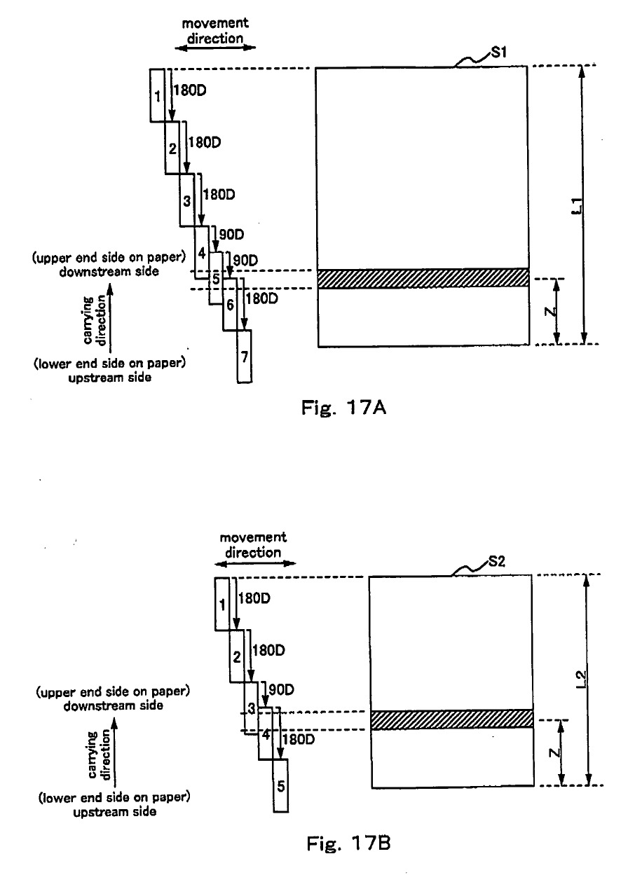

FIGS. 17A and 17B are explanatory diagrams of a printing method in a comparative example. FIG. 17A shows the positions of the head with respect to paper when paper S1 with a length L1 in the carrying direction is printed. FIG. 17B shows the positions of the head with respect to paper when paper S2 with a length L2 in the carrying direction is printed. Rectangles indicating the positions of the head are shown on the left side in the drawings, and the numbers in the rectangles indicate the pass numbers. As shown in the drawings, in this comparative example, the first printing method (the band printing in an ordinary area, and the overlap printing in an image quality deterioration portion) described above is applied. The hatched portions on the paper in the drawings show image quality deterioration portions, and these portions correspond to the “two-pass areas”.

Herein, for the sake of convenience, the size of the paper with respect to the head is made small (in the case of A4 paper, the length in the carrying direction is 297 mm, and the length of the head in the carrying direction is about 1 inch (25.4 mm), and thus even when all areas are printed by the band printing, at least 11 passes are necessary). Furthermore, for the sake of convenience, the width of the “two-pass area” in the carrying direction is set to be short (in ordinary cases, the width of the two-pass area in the carrying direction is set to around the head width (the length of the nozzle row)).

In this comparative example, the position of the head with respect to the paper S in a first pass is constant regardless of the length of the paper in the carrying direction. More specifically, in this comparative example, the position of the upper end of the paper when the paper is supplied is constant regardless of the length of the paper S in the carrying direction. For example, in the printing method shown in the drawings, the upper end of the paper is positioned on the most downstream side on the head in the carrying direction when the paper is supplied.

As described above, the image quality deterioration portions indicated by the hatched portions in the drawings are portions in which the image quality is deteriorated by being affected by the lower end of the paper S passing the carry roller (see FIG. 12). Thus, the image quality deterioration portions are positioned away from the lower end of the paper by a predetermined distance Z regardless of the length of the paper S in the carrying direction. As a result, the length from the upper end of the paper to the image quality deterioration portions differs depending on the length of the paper in the carrying direction.

Thus, as in the comparative example, if the position of the upper end of the paper when the paper is supplied is made constant regardless of the length of the paper in the carrying direction, ink ejection from the nozzles when the “two-pass area” is printed differs depending on the length of the paper in the carrying direction. For example, in a pass (pass 4 in FIG. 17A, pass 3 in FIG. 17B) at the time of starting the printing of the “two-pass area”, the nozzle on the most upstream side in the carrying direction form dots at every other dot in order to print the “two-pass area” in FIG. 17A, but in FIG. 17B, the nozzle on the most upstream side in the carrying direction is positioned outside the two-pass area, and thus the nozzle does not eject ink.

Furthermore, as in the comparative example, if the position of the upper end of the paper when the paper is supplied is made constant regardless of the length of the paper in the carrying direction, the carry amount in the carrying process differs depending on the length of the paper in the carrying direction. For example, in FIG. 17A, the “two-pass area” is printed in three passes, and thus the carrying process by a carry amount of 90 D is performed twice. However, in FIG. 17B, the “two-pass area” is printed in two passes, and thus the carrying process by a carry amount of 90 D is performed only once.

In this manner, if ink ejection from the nozzles differs depending on the length of the paper in the carrying direction, or if the carrying process differs depending on the length of the paper in the carrying direction, it is necessary for the printer driver to change the rasterization process or the command addition process in accordance with the length of the paper in the carrying direction, although the same printing method is applied. However, in this state, the processes that are to be performed by the printer driver become complex, and a vast amount of information is to be provided in the printer driver.

Thus, in this embodiment described below, the position of the paper when the paper is supplied (an initial position) is changed in accordance with the length of the paper in the carrying direction. Thus, it is possible to print the “two-pass area” in the same manner regardless of the length of the paper in the carrying direction.

In the Case of This Embodiment

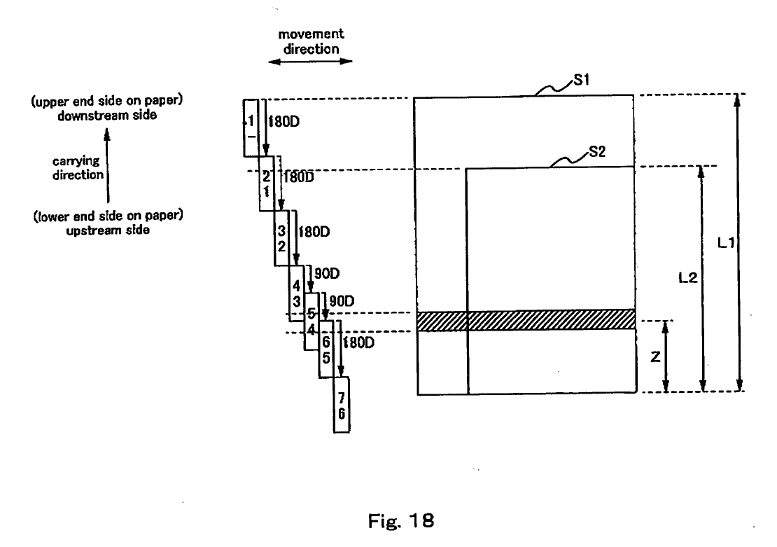

FIG. 18 is an explanatory diagram of the printing method in this embodiment. Rectangles indicating the positions of the head are shown on the left side in the drawing. Of the numbers in the rectangles, the upper numbers indicate the pass numbers when the paper S1 (paper with the length L1 in the carrying direction) is printed, and the lower numbers indicate the pass numbers when the paper S2 (paper with the length L2 in the carrying direction) is printed.

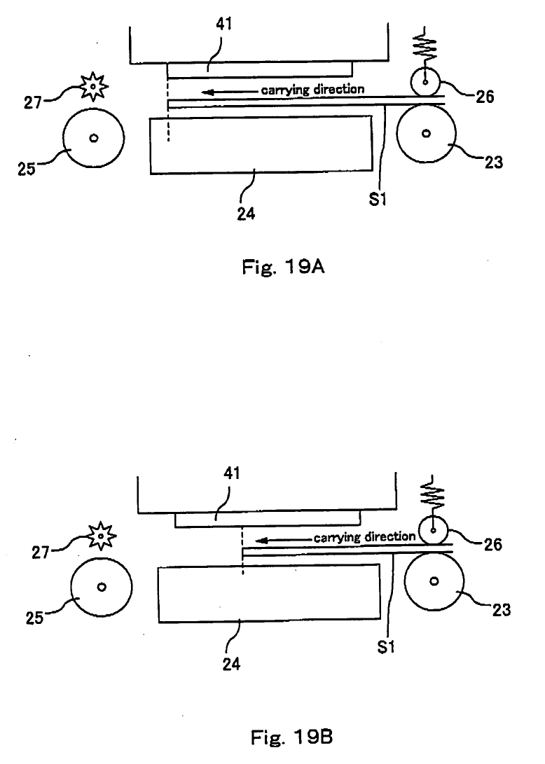

Furthermore, FIG. 19A is an explanatory view of the position of the upper end when the paper S1 is supplied. FIG. 19B is an explanatory view of the position of the upper end when the paper S2 is supplied.

When the paper S1 is printed, the printer supplies the paper S1 by driving the carry roller 23 until the upper end is positioned on the most downstream side on the head in the carrying direction as shown in FIG. 19A. Then, after the paper is supplied to this position, a first pass is performed. Then, the printer performs the band printing by repeating alternately the pass (dot forming process) and the carrying process. From pass 1 to pass 3, each nozzle forms raster lines in a single pass, and the carrying process by a carry amount of 180 D is performed between the passes. Printing of the “two-pass area” is started from pass 4. In pass 4, the nozzles in the “one-pass area” form raster lines in a single pass, and the nozzles in the “two-pass area” form dots at every other dot. The carrying process by a carry amount of 90 D is performed between pass 4 and pass 5. In pass 5, the nozzles in the “one-pass area” do not eject ink, and the nozzles in the “two-pass area” form dots at every other dot. The carrying process by a carry amount of 90 D is performed between pass 5 and pass 6. In pass 6, the nozzles in the “one-pass area” form raster lines in a single pass, and the nozzles in the “two-pass area” form dots at every other dot. Subsequently, printing in the band printing is performed.

When the paper 52 is printed, the printer supplies the paper S2 by driving the carry roller 23 in order to position the upper end on the upstream side in the carrying direction with respect to the most downstream side on the head in the carrying direction as shown in FIG. 19B. Then, after the paper is supplied to this position, a first pass is performed. Then, the printer performs the band printing by repeating alternately the pass (dot forming process) and the carrying process. In pass 1 and pass 2, each nozzle forms raster lines in a single pass, and the carrying process by a carry amount of 180 D is performed between the passes. Printing of the “two-pass area” is started from pass 3. In pass 3, the nozzles in the “one-pass area” form raster lines in a single pass, and the nozzles in the “two-pass area” form dots at every other dot. The carrying process by a carry amount of 90 D is performed between pass 3 and pass 4. In pass 4, the nozzles in the “one-pass area” do not eject ink, and the nozzles in the “two-pass area” form dots at every other dot. The carrying process by a carry amount of 90 D is performed between pass 4 and pass 5. In pass 5, the nozzles in the “one-pass area” form raster lines in a single pass, and the nozzles in the “two-pass area” form dots at every other dot. Subsequently, printing in the band printing is performed.

In this embodiment, regardless of the length of the paper in the carrying direction, the positional relationship of the head to the “two-pass area” becomes the same. For example, the position of the head in pass 4 with respect to the “two-pass area” on the paper S1 is the same as the position of the head in pass 3 with respect to the “two-pass area” on the paper S2. Thus, the nozzles forming raster lines in a single pass in pass 4 while the paper S1 is printed are the same as the nozzles forming raster lines in a single pass in pass 3 while the paper S2 is printed. Furthermore, the nozzles forming dots at every other dot in pass 4 while the paper S1 is printed are the same as nozzles forming dots at every other dot in pass 3 while the paper S2 is printed. In a similar manner, in this embodiment, ink ejection from each nozzle in pass 5 and pass 6 while the paper S1 is printed is the same as ink ejection from each nozzle in pass 4 and pass 5 while the paper S2 is printed.

Thus, in this embodiment, when the printer driver performs a rasterization process, it is possible to perform a rasterization process in the same manner regardless of the length of paper in the carrying direction. For example, image data that is to be extracted in accordance with pass 4 when the paper S1 is printed is the same as image data that is to be extracted in accordance with pass 3 when the paper S2 is printed, and thus it is possible to perform the same rasterization process.

Furthermore, in this embodiment, it is possible to perform the carrying process in the same manner regardless of the length of paper in the carrying direction. For example, the carrying processes in pass 2 to pass 7 when the paper S1 is printed are the same as the carrying processes in pass 1 to pass 6 when the paper S2 is printed. Thus, in this embodiment, when the printer driver performs the command addition process, it is possible to perform the command addition process in the same manner regardless of the length of paper in the carrying direction.

As shown clearly in the description above, in this embodiment, it is possible to perform the same dot forming process and carrying process regardless of the length of the paper S in the carrying direction, by changing the position of the paper when the paper is supplied, in accordance with the length of the paper in the carrying direction. Thus, the processes that are to be performed by the printer driver become the same, and it is possible to reduce the amount of information that is to be provided in the printer driver.

It should be noted that in this embodiment, for the sake of convenience, the first printing method (the band printing in an ordinary area, and the overlap printing in an image quality deterioration portion) described above is applied. However, the invention is not limited thereto. Even if the second printing method (the interlaced printing in an ordinary area, and the full overlap printing in an image quality deterioration portion) described above is applied, it is possible to perform the same dot forming process and carrying process regardless of the length of the paper S in the carrying direction, by changing the position of the paper when the paper is supplied, in accordance with the length of the paper in the carrying direction.

### The Second Embodiment

In the first embodiment, when an image quality deterioration portion is printed at a high image quality, the position of paper when the paper is supplied is changed in accordance with the length of the paper in the carrying direction. However, even if this printing method is not applied, the position of paper when the paper is supplied may be changed in accordance with the length of the paper in the carrying direction.

Regarding State After Lower End has Passed Carry Roller

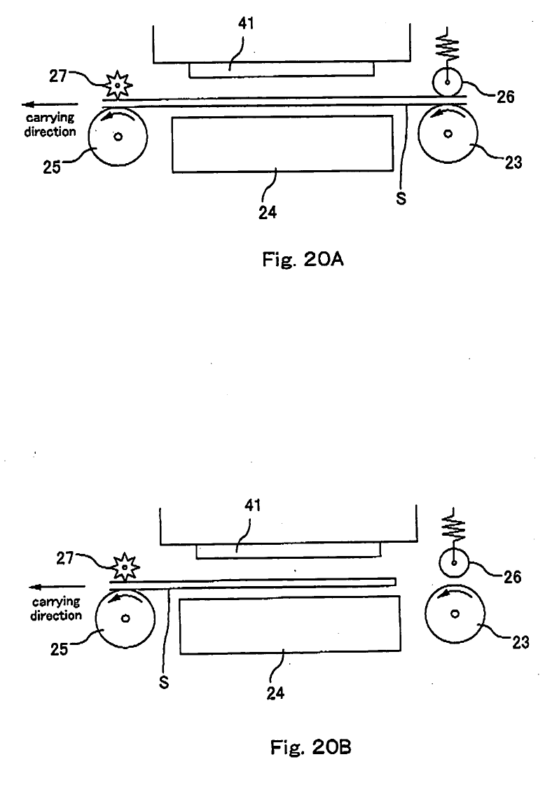

FIG. 20A is an explanatory view of a state during an ordinary carrying process. FIG. 20B is an explanatory view of a state during a carrying process after a lower end of paper has passed the carry roller.

The carry roller 23 positioned on the upstream side of the print area in the carrying direction and the paper discharge roller 25 positioned on the downstream side of the print area in the carrying direction are rotated in synchronization with each other. Also, during an ordinary carrying process, paper S is carried by the two rollers, namely the carry roller 23 and the paper discharge roller 25.

However, the carrying states before and after the lower end of the paper S passes the carry roller 23 are different. For example, after the lower end of the paper S has passed the carry roller 23, the paper S is carried only by the paper discharge roller 25, and thus this state is different from the state in which the paper is carried by the two rollers (ordinary carrying state). Also, the carry roller 23 and the paper discharge roller 25 have the different shapes (such as the radius and the cross-sectional shape). Further, the roller provided opposed to the paper discharge roller 25 has a shape different from the shape of the driven roller on the side of the carry roller 23 in order to reduce contact with the printing surface. Also, in order to prevent creases in the paper during ordinary carrying, the printer is designed so that the carrying speed of the paper discharge roller 25 is slightly faster than the carrying speed of the carry roller 23. Because of these factors, the carrying state after the lower end of the paper S has passed the carry roller 23 is different from the ordinary carrying state. Furthermore, since the contact area between the paper discharge roller and the paper is small, it is impossible to perform carrying stably in a carrying operation using only the paper discharge roller.

As a result, dots formed after the lower end of the paper S has passed the carry roller 23 are displaced in the carrying direction with respect to dots formed before the lower end of the paper S has passed the carry roller 23. Thus, a striped pattern extending in the movement direction appears between an image printed before the lower end of the paper S has passed the carry roller 23 and an image printed after the lower end of the paper S has passed the carry roller 23, so that the image quality is deteriorated.

Accordingly, in order to perform printing at a high image quality, it is desirable to complete printing before the lower end of the paper S has passed the carry roller 23.

Regarding Printing Method in the Second Embodiment

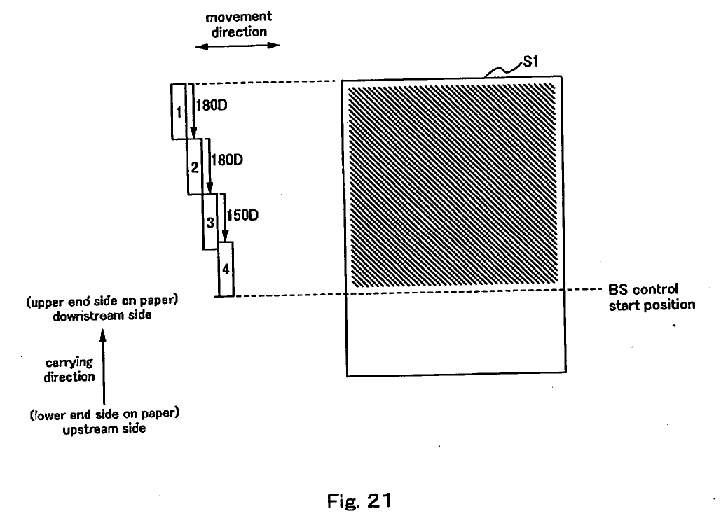

FIG. 21 is an explanatory diagram of a printing method in which printing is completed before the lower end has passed the carry roller. Herein, it is assumed that printing in the band printing is performed. More specifically, raster lines are formed in a single pass. However, in this embodiment, in the carrying process that is immediately before the last pass (pass 4), paper is carried by a carry amount of 150 D, which is smaller than by a carry amount of 180 D.

If the carrying process by a carry amount of 180 D is performed between pass 3 and pass 4, the nozzle (nozzle #180) on the most upstream side on the head in the carrying direction is positioned on the upstream side in the carrying direction than the BS control start position. As a result, the lower end of the paper may pass the carry roller 23, and thus the image quality of image fragments formed in pass 4 may be deteriorated.

On the other hand, if an image to be printed is positioned on the upper end of the paper than the BS control start position (if a raster line on the lowermost side (on the most upstream side in the carrying direction) among raster lines constituting a print image is positioned on the downstream side in the carrying direction than the BS control start position), then it is possible to print the print image on the paper even if the carrying process is ended before the lower end of the paper has passed the carry roller 23. Thus, in this embodiment, after pass 3, the paper is carried until the nozzle on the most upstream side on the head in the carrying direction is opposed to the BS control start position on the paper (state in FIG. 12), and pass 4 is performed. Accordingly, in pass 4, it is possible to form dots in a state in which the paper S is carried by the two rollers, namely the carry roller 23 and the paper discharge roller 25.

It should be noted that a part of the nozzles in pass 4 has the same position with respect to the paper as a part of the nozzles in pass 3. Accordingly, in pass 4, the part of the nozzles does not eject ink.

Herein, the “BS control start position” is positioned away from the lower end of the paper by a predetermined distance regardless of the length of the paper S in the carrying direction. Accordingly, if the position of the upper end of the paper when the paper is supplied is made constant regardless of the length of the paper in the carrying direction, the carry amount of the carrying process performed immediately before the last pass differs depending on the length of the paper in the carrying direction. Further, the nozzles that do not eject ink in the last pass differ depending on the length of the paper in the carrying direction. Thus, also in this embodiment, the position of the paper when the paper is supplied (an initial position) is changed in accordance with the length of the paper in the carrying direction.

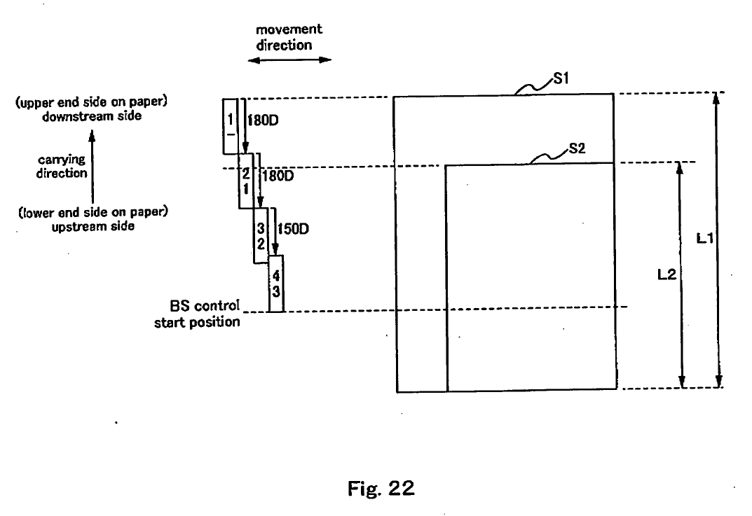

FIG. 22 is an explanatory diagram of the printing method in this embodiment.

When the paper S1 is printed, the printer supplies the paper S1 by driving the carry roller 23 until the upper end is positioned on the most downstream side on the head in the carrying direction as shown in FIG. 19A. On the other hand, when the paper S2 is printed, the printer supplies the paper S2 by driving the carry roller 23 in order to position the upper end on the upstream side in the carrying direction with respect to the most downstream side on the head in the carrying direction as shown in FIG. 19B.

Accordingly, in this embodiment, the carry amount of the carrying process performed immediately before the last pass becomes the same regardless of the length of the paper in the carrying direction. Furthermore, a part of the nozzles in the last pass do not eject ink, but the nozzles that do not eject ink are the same regardless of the length of the paper in the carrying direction.

Thus, in this embodiment, when the printer driver performs a rasterization process, it is possible to perform a rasterization process in the same manner regardless of the length of the paper in the carrying direction. Furthermore, in this embodiment, when the printer driver performs the command addition process, it is possible to perform the command addition process in the same manner regardless of the length of the paper in the carrying direction.

Furthermore, if an image to be printed is positioned on the lower end of the paper than the BS control start position (if a raster line on the lowermost side (on the most upstream side in the carrying direction) among raster lines constituting a print image is positioned on the upstream side in the carrying direction than the BS control start position), then printing may not be ended before the lower end of the paper has passed the carry roller 23. In other words, in this case, when forming the raster line on the lowermost side, the lower end of the paper has passed the carry roller 23. Under this circumstance, it is meaningless to reduce the carry amount of the carrying process performed immediately before the last pass, or to change the initial position when the paper is supplied in accordance with the length of the paper in the carrying direction. Thus, in this case, it is possible not to change the initial position when the paper is supplied in accordance with the length of the paper in the carrying direction, and to apply an ordinary carry amount in the carrying process performed immediately before the last pass.

### Other Embodiments

The foregoing embodiments are described primarily with regard to a printer. However, the foregoing embodiments are for the purpose of elucidating the present invention and are not to be interpreted as limiting the present invention. The invention can of course be altered and improved without departing from the gist thereof and includes functional equivalents thereof.

Overview

(1) In the printing methods described above, a print image is printed on paper by repeating alternately a dot forming process and a carrying process, thereby consecutively arranging a raster line (an example of a dot row) in a carrying direction on the paper (an example of a medium). Herein, the dot forming process is a process in which a dot is formed on paper by ejecting an ink droplet (an example of a liquid droplet) from a plurality of nozzles moving in a movement direction, and is also referred to as a “pass”. Furthermore, the carrying process is a process in which paper is carried in the carrying direction.

If the position of an upper end of paper when the paper is supplied is made constant regardless of the length of the paper in the carrying direction, then it is necessary to change the dot forming process or the carrying process in accordance with the length of the paper in the carrying direction (see FIGS. 17A and 17B). In order to change the dot forming process or the carrying process in accordance with the length of the paper in the carrying direction, it is necessary to change a rasterization process or a command addition process in accordance with the length of the paper in the carrying direction. Thus, processes that are to be performed by a printer driver become complex, and a vast amount of information is to be provided in the printer driver.

Thus, in the printing methods described above, the position of paper when the paper is supplied (an initial position) is changed in accordance with the length of the paper in the carrying direction (see FIGS. 18 and 22). Accordingly, it is possible to perform the dot forming process and the carrying process in the same manner regardless of the length of the paper in the carrying direction.

Although clearly shown in the description above, the paper supply process described above is described. First, a user sets the printer driver by selecting a “paper size” or other items via a user interface of the printer driver. In accordance with the setting details, the printer driver (more specifically, a computer on which the printer driver is installed) determines the length of the paper in the carrying direction, and sets the initial position according to the length of the paper in the carrying direction. Next, the printer driver creates command data for the paper supply process in accordance with the initial position that has been set, and transmits print data including this command data to a printer. The printer supplies (carries) the paper to the initial position specified by the command data, by controlling a carry unit in accordance with the command data in the print data. Accordingly, the paper supply process described above is realized.
(2) In the first embodiment described above (see FIG. 18), a “one-pass area” positioned in the central portion of paper is printed by the band printing (an example of a first print mode), and a “two-pass area” away from the lower end of the paper by a predetermined distance Z is printed by the overlap printing (an example of a second print mode). The “two-pass area” is positioned away from the lower end by the predetermined distance regardless of the length of the paper in the carrying direction, and thus it is possible to form the “two-pass area” by a dot forming process and a carrying process in the same manner regardless of the length of the paper in the carrying direction, by changing the initial position in accordance with the length of the paper in the carrying direction.

In a similar manner, in the second embodiment described above (see FIG. 22), the central portion of paper is printed by performing the band printing to a pass immediately before a last pass. Then, immediately before the last pass, the carrying process is performed by a carry amount smaller than that in the ordinary band printing. The last pass is performed in a state in which a part of the nozzles does not eject ink (an example of the second print mode), and an area away from the lower end by a predetermined distance is printed. In the second embodiment, it is possible to perform the carrying process mediately before the last pass and the last pass in a similar manner regardless of the length of the paper in the carrying direction, by changing the initial position in accordance with the length of the paper in the-carrying direction.
(3) In the first embodiment described above, a raster line is formed by one nozzle in the band printing (or interlaced printing), and a raster line is formed by two nozzles in the overlap printing (or full overlap printing). When a raster line is formed by two nozzles, even if dots formed by one nozzle among the two nozzles are displaced, the influence on the raster line is reduced by half. Thus, it is possible to obtain a higher image quality than in a case where a raster line is formed by one nozzle.
(4) In the first embodiment described above, as shown in FIGS. 15 and 16, it is also possible that the “one-pass area” positioned in the central portion of paper (an example of a first area) is printed by the interlaced printing (first print mode), and that the “two-pass area” (an example of a second area) is printed by the full overlap printing (second print mode). Then, a mixed area is formed between the one-pass area and the two-pass area. In this mixed area, a dot row formed by one nozzle as in the interlaced printing and a dot row formed by two nozzles as in the full overlap printing are present in a mixed state. If this mixed area is formed between the one-pass area and the two-pass area, the difference in the image quality between the one-pass area and the two-pass area becomes less remarkable, and thus it is possible to suppress deterioration of the image quality of the entire print image.
(5) In the printing methods described above, in the mixed area, more than half the raster lines formed by one nozzle as in the interlaced printing are formed at positions closer to the one-pass area than to the two-pass area (see FIG. 15, for example).

Thus, even in the same mixed area, the image quality close to that in the interlaced printing is obtained on the side close to the one-pass area, and the image quality close to that in the full overlap printing is obtained on the side close to the two-pass area. If the mixed area having this image quality is formed between the one-pass area and the two-pass area, change in the image quality from the one-pass area to the two-pass area becomes very moderate, and thus the difference in the image quality between the one-pass area and the two-pass area becomes less remarkable.
(6) In the second embodiment described above, an image to be printed is positioned on the downstream side in the carrying direction than the BS control start position, which is away from the lower end by a predetermined distance. Thus, if a raster line on the most upstream side in the carrying direction is positioned on the downstream side in the carrying direction than the position away from the lower end by the predetermined distance, the raster line on the most upstream side in the carrying direction is formed in the last pass after the paper has been carried by a carry amount smaller than that in the band printing. Accordingly, in the last pass, it is possible to form a dot in a state in which the paper is carried by two rollers, namely a carry roller and a paper discharge roller.
(7) If the raster line in the most upstream side in the carrying direction is positioned on the upstream side in the carrying direction than the BS control start position, which is away from the lower end by a predetermined distance, the lower end of the paper has passed the carry roller when the raster line in the most upstream side in the carrying direction is formed. Thus, in this case, printing is performed in an ordinary print mode until the last pass is printed, without changing the initial position when the paper is supplied in accordance with the length of the paper in the carrying direction.
(8) Combining all of the structural elements of the foregoing embodiments is desirable because all of the effects can be attained. However, it is not necessary to include all of the structural elements.
(9) In the foregoing embodiments, a printer driver (more specifically, a computer on which the printer driver is installed) creates print data, and the printer driver transmits the print data to a printer. A controller 60 of the printer controls a carry unit 20, a carriage unit 30, and a head unit 40 in accordance with the print data, and thereby the printing methods described above are realized.

With a printing system having the printer and the computer on which the printer driver is installed, it is possible to perform a dot forming process and a carrying process in the same manner regardless of the length of paper in the carrying direction. In this case, a CPU of the computer on which the printer driver is installed and the controller 60 of a printer 1 serve as a controller of the entire printing system.

It should be noted that a part of a function of the printer driver to create print data can be provided on the printer. In this case, the controller 60 of the printer 1 serves as the controller of the entire printing system.
(10) Print data that is created by a printer driver includes data specifying a pixel in which a dot is formed by a nozzle in a pass and command data indicating such items as a carry amount. In other words, the printer driver creates print data for the printing methods in the foregoing embodiments, and transmits the print data to a printer. With this printer driver (an example of a program), it is possible to let the printer perform a dot forming process and a carrying process in the same manner regardless of the length of paper in the carrying direction. Furthermore, with this printer driver, a process that is to be performed by the printer driver became the same, and it is possible to reduce the amount of information that is to be provided in the printer driver, so that the configuration becomes simple.

What is claimed is:

1. A printing method comprising:
setting an initial position according to a length of a medium in a carrying direction;
carrying the medium to the initial position that has been set; and
arranging in the carrying direction on the medium a plurality of dot rows each constituted by a plurality of dots that are aligned in a movement direction, by repeating alternately a dot forming process for forming a dot on the medium by ejecting a liquid droplet from a plurality of nozzles that move in the movement direction and a carrying process for carrying the medium in the carrying direction.

2. A printing method according to claim 1, wherein,
when a plurality of the dot rows are arranged in the carrying direction on the medium,
the dot row is formed in a first print mode in an area of a central portion of the medium, and
the dot row is formed in a second print mode that is different from the first print mode in an area away from a lower end of the medium by a predetermined distance.

3. A printing method according to claim 2, wherein,
in the first print mode, the dot row is formed by a predetermined number of nozzles, and
in the second print mode, the dot row is formed by a predetermined number of nozzles that is different from the predetermined number of the nozzles in the first print mode.

4. A printing method according to claim 3, wherein,
between a first area in which a plurality of the dot rows formed by the predetermined number of the nozzles in the first print mode are arranged and a second area in which a plurality of the dot rows formed by the predetermined number of the nozzles in the second print mode are arranged, a mixed area is formed in which the dot rows formed by the predetermined number of the nozzles in the first print mode and the dot rows formed by the predetermined number of the nozzles in the second print mode are present in a mixed state.

5. A printing method according to claim 4, wherein,
in the mixed area, more than half the dot rows formed by the predetermined number of the nozzles in the first print mode are formed at positions closer to the first area than to the second area.

6. A printing method according to claim 2, wherein,
if the dot row on a most upstream side in the carrying direction among the dot rows that are to be formed on the medium is positioned on a downstream side in the carrying direction than a position away from the lower end by the predetermined distance, the dot row on the most upstream side in the carrying direction is formed in the second print mode.

7. A printing method according to claim 6, wherein,
if the dot row on the most upstream side in the carrying direction among the dot rows that are to be formed on the medium is positioned on an upstream side in the carrying direction than the position away from the lower end by the predetermined distance, carrying of the medium to the initial position according to the length of the medium in the carrying direction is not performed.

8. A printing method comprising:
setting an initial position according to a length of a medium in a carrying direction;
carrying the medium to the initial position that has been set; and
arranging in the carrying direction on the medium a plurality of dot rows each constituted by a plurality of dots that are aligned in a movement direction, by repeating alternately a dot forming process for forming a dot on the medium by ejecting a liquid droplet from a plurality of nozzles that move in the movement direction and a carrying process for carrying the medium in the carrying direction, wherein:
when a plurality of the dot rows are arranged in the carrying direction on the medium,
the dot row is formed in a first print mode in an area of a central portion of the medium, and
the dot row is formed in a second print mode that is different from the first print mode in an area away from a lower end of the medium by a predetermined distance;
in the first print mode, the dot row is formed by a predetermined number of nozzles; and
in the second print mode, the dot row is formed by a predetermined number of nozzles that is different from the predetermined number of the nozzles in the first print mode;
between a first area in which a plurality of the dot rows formed by the predetermined number of the nozzles in the first print mode are arranged and a second area in which a plurality of the dot rows formed by the predetermined number of the nozzles in the second print mode are arranged, a mixed area is formed in which the dot rows formed by the predetermined number of the nozzles in the first print mode and the dot rows formed by the predetermined number of the nozzles in the second print mode are present in a mixed state;
in the mixed area, more than half the dot rows formed by the predetermined number of the nozzles in the first print mode are formed at positions closer to the first area than to the second area; and
in the first print mode, the carrying process is performed by a predetermined carry amount, and
in the second print mode, the carrying process is performed by a predetermined carry amount that is different from the predetermined carry amount in the first print mode.

9. A printing system comprising:
a carry unit for carrying a medium in a carrying direction;
a moving member for moving a plurality of nozzles in a movement direction; and
a controller
for setting an initial position according to a length of the medium in the carrying direction and letting the carry unit carry the medium to the initial position that has been set, and
for arranging in the carrying direction on the medium a plurality of dot rows each constituted by a plurality of dots that are aligned in the movement direction, by repeating alternately a dot forming process for forming a dot on the medium by ejecting a liquid droplet from a plurality of the nozzles that move in the movement direction and a carrying process for carrying the medium in the carrying direction by the carry unit.

10. A storage medium storing a program that lets a printing system realize:
a function to set an initial position according to a length of a medium in a carrying direction;
a function to carry the medium to the initial position that has been set; and
a function to arrange in the carrying direction on the medium a plurality of dot rows each constituted by a plurality of dots that are aligned in a movement direction, by repeating alternately a dot forming process for forming a dot on the medium by ejecting a liquid droplet from a plurality of nozzles that move in the movement direction and a carrying process for carrying the medium in the carrying direction.
